(19) United States
(12) Patent Application Publication
(10) Pub. No.: US 2005/0175104 A1
(43) Pub. Date: Aug. 11, 2005

(54) Video communication apparatus and video communication method

(76) Inventors: Yoshimasa Honda, Kamakura-shi (JP); Daijiro Ichimura, Tokyo (JP)

Correspondence Address: NATH & ASSOCIATES PLLC;Sixth Floor, 1030 15th Street, N.W., Washington, DC, 20005-1503, US

(21) Appl. No.: 11/045,594

(22) Filed: Jan. 31, 2005

(30) Foreign Application Priority Data
Feb. 10, 2004 (JP) 2004-033587

(51) Int. Cl. H04N 7/12

(52) U.S. Cl. 375/240.18; 375/240.23

(57) ABSTRACT

The present invention improves confidentiality of video without incurring increased processing load. Coefficient scanner 123 scans the orthogonal transform coefficients of the base layer in scanning orders specified by scanning order determiner 150. Coefficient scanner 133 scans the orthogonal transform coefficients of the enhancement layer in scanning orders specified by scanning order determiner 150. When scanning is implemented in a privacy mode, scanning order determiner 150 determines the privacy mode scanning orders of the base layer and the enhancement layer individually and generates scan lists that indicate the scanning orders of the base layer and the enhancement layer respectively. Scan list transmitter 180 the scan lists of the base layer and the enhancement layer, generated in scanning order determiner 150, to specific users alone.

### BACKGROUND OF THE INVENTION

1. Field of the Invention

The present invention relates to a video communication apparatus and video communication method. More particularly, the present invention relates to a video communication apparatus and video communication method for transmitting and receiving video data coded by layered coding scheme.

2. Description of Related Art

Video coding technology has developed remarkably over the recent years. Presently, it is possible to compress and encode a video signal below a certain bandwidth, using, for example, the JPEG (Joint Picture Experts Group) scheme, the H. 261 scheme, and the MPEG (Moving Picture Experts Group) scheme, making it possible to transmit compressed encoded video via a network at ease.

Moreover, to transmit video via a network where the transmission bandwidth keeps fluctuating (e.g. the Internet), the layered coding scheme is often used that enables adaptive bandwidth adjustment within an available bandwidth range. In particular, according to the layered coding scheme of MPEG-4 FGS (Fine Granularity Scalability, ISO/IEC 14496-2 Amendment 2), standardized in 2002, two types of layers—that is, the base layer and the enhancement layer—are coded to control the amount of coded data in the enhancement layer. By this means, it is possible to implement video transmission and video playback at quality levels (e.g., PSNR (Peak Signal to Noise Ratio) and frame rate) in accordance with the bandwidth of the network.

In the recent years, techniques such as described above have made it possible to monitor the video recorded by surveillance cameras on city corners and in the household, at a remote location, via a network, such as typified by the web camera. In addition, from now on, it is predictable that an increased number of surveillance cameras will be installed to combat terrorism and crimes, and it will become more frequent to monitor surveillance camera video via a network to efficiently monitor the video from a great number of surveillance cameras.

Under these circumstances, an indefinite, great number of users having access to the network will be able to receive and monitor surveillance camera video, and this will create significant problems in terms of privacy protection. Consequently, it will also become necessary to improve the confidentiality of video, for example, by applying encryption processing to surveillance camera video and by utilizing the IPSec function in IPv6 (Internet Protocol version 6). However, this IPSec function encrypts all IP packets in a uniform way and transmits these packets, which makes it difficult to implement flexible control responsive to user demands. For this reason, to improve the confidentiality of surveillance camera video, it is desirable to subject video data to encryption processing and transmit the result.

Meanwhile, the amount of video data has been increasing with increase in the number of pixels in surveillance cameras, that is, with increase in the resolution of video. Generally, the processing load in encryption processing such as described above is proportionate to the amount of data. That is, an increase in the amount of data will result in an increase in the processing load in encryption and decryption processing. Results of this include increased cost of surveillance cameras and the receiving terminals to receive surveillance camera video, and processing delay due to encryption and decryption processing. Now, it is anticipated to improve the confidentiality of video by means of encryption processing and prevent the processing load in encryption processing from increasing.

To meet these contradicting needs, heretofore, video data is subjected to layered coding and only part of the layers is subjected to encryption processing, for reduced load in the encryption processing. For example, patent document No. 1 (Laid-Open Japanese Patent Application Publication No. HEI 11-331618) provides an example. That is, the image processing apparatus in above patent document No. 1 subjects inputted video to hierarchical coding and executes encryption processing partially from high quality hierarchies, thereby reducing the load in the encryption processing compared to when entire video is encrypted.

In addition, patent document No. 2 (Laid-Open Japanese Patent Application Publication No. 2002-374421) discloses improving confidentiality of video by rearranging the blocks of video divided into smaller components. To be more specific, the image processing apparatus of patent document No. 2 subjects inputted video to wavelet transform, implement coding on a per block basis in an arbitrary order, thereby enabling video playback only when decoding is performed in the same order of the blocks as in the coding, and making it possible to improve the confidentiality of video compared to encryption processing.

However, referring to above patent document No. 1, the above-described scheme of executing encryption processing with respect to only certain layer still has the problem that the processing load may yet increase depending on the amount of video data subject to encryption processing. In particular, the processing load required to encrypt high resolution video is enormous even when only certain layer is subject to the encryption processing. In addition, executing more intense encryption processing for yet higher confidentiality will further increase the processing load.

Moreover, with the scheme of improving confidentiality by way of block order rearrangement such as disclosed in above patent document No. 2, it is still possible to decode the blocks individually, and, consequently, the problem persists that video in block units may leak to an uncertain, great number of users. If video in block units can be decoded, it will be easy to decipher entire video from image information in the neighboring blocks, protection of privacy will become imperfect.

Moreover, if the kind of coding is employed that utilizes the wavelet transform, zero-tree coding utilizing the zero correlation between blocks is also used for improved coding efficiency. However, changing the coding order of the blocks will change the zero-tree configuration, and this will result in deterioration in coding efficiency. Furthermore, when the technique disclosed in patent document No. 2 is applied to MPEG-4 FGS that utilizes the DCT (Direct Cosine Transform), not the wavelet transform, it will become easy to decipher entire video as mentioned above, privacy is not protected completely.

### SUMMARY OF THE INVENTION

It is therefore an object of the present invention to provide a video communication apparatus and video communication method that improves the confidentiality of video subject to transmission and reception without increasing processing load.

According to an aspect of the present invention, a video communication terminal apparatus is provided that has a determiner that determines a privacy mode scanning order, the scanning order being different from a normal mode scanning order; a scanner that scans orthogonal transformed coefficients obtained from input video in the privacy mode scanning order; a coder that encodes scanned values and generates a video stream; and a transmitter that transmits the video stream and information about the privacy mode scanning order, and, in this apparatus, the transmitter transmits the information about the privacy mode scanning order only to specific users having authority to play the video stream.

According to another aspect of the present invention, a video communication apparatus is provided that has a receiver that receives a video stream; a decider that determines whether or not information about a scanning order corresponding to the video stream is received; and a reverse scanner that reverse scans the video stream in accordance with the information about the scanning order when the information is received and that reverse scans the video stream in a normal mode scanning order when the information is not received.

According to yet another aspect of the present invention, a video communication method is provided that has the steps of: determining a privacy mode scanning order, the scanning order being different from a normal mode scanning order; scanning orthogonal transform coefficients obtained from input video in the privacy mode scanning order; encoding scanned values and generating a video stream; and transmitting the video stream; and transmitting the information about the privacy mode scanning order only to specific users having authority to play the video stream.

According to yet another aspect of the present invention, a video communication method is provided that has the steps of: receiving a video stream; determining whether or not information about a scanning order corresponding to the video stream is received; and reverse scanning the video stream in accordance with the information about the scanning order when the information is received and reverse scanning the video stream in a normal mode scanning order when the information is not received.

### BRIEF DESCRIPTION OF THE DRAWINGS

The above and other objects and features of the invention will appear more fully hereinafter from a consideration of the following description taken in connection with the accompanying drawings wherein examples are illustrated, in which:

FIG. 1 is a block diagram showing a configuration of a video transmitting apparatus according to Embodiment 1;

FIG. 2 is a block diagram showing a configuration of a video receiving apparatus according to Embodiment 1;

FIG. 3 is a flowchart showing the operation of the video transmitting apparatus of embodiment 1;

FIG. 4 is a flowchart showing base layer coding processing by the video transmitting apparatus of Embodiment 1;

FIG. 5 is a flowchart showing enhancement layer coding processing by the video transmitting apparatus of Embodiment 1;

FIG. 6A shows an example of a normal mode scanning pattern;

FIG. 6B shows an example of a privacy mode scanning pattern;

FIG. 7A shows an example of a scan list header;

FIG. 7B shows an example of a scan matrix;

FIG. 8A shows an example of orthogonal transform coefficients in blocks;

FIG. 8B shows orthogonal transform coefficients in normal mode scanning;

FIG. 8C shows orthogonal transform coefficients in privacy mode scanning;

FIG. 9 is a flowchart showing the operation of the video receiving apparatus of Embodiment 1;

FIG. 10 is a flowchart showing base layer decoding processing by the video receiving apparatus of Embodiment 1;

FIG. 11A shows an example of orthogonal transform coefficientes in blocks;

FIG. 11B shows orthogonal transform coefficients in privacy mode scanning;

FIG. 11C shows orthogonal transform coefficients in normal mode scanning;

FIG. 11D shows orthogonal transform coefficients in privacy mode reverse scanning;

FIG. 12 is a flowchart showing enhancement layer decoding processing by the video receiving apparatus of Embodiment 1;

FIG. 13 is a block diagram showing a configuration of a video transmitting apparatus according to Embodiment 2 of the present invention;

FIG. 14 is a block diagram showing a configuration of a video receiving apparatus according to Embodiment 2;

FIG. 15 is a flowchart showing the operation of the video transmitting apparatus of Embodiment 2;

FIG. 16 illustrates an example of image recognition according to Embodiment 2;

FIG. 17 is a flowchart showing the operation of the video receiving apparatus of Embodiment 2;

FIG. 18 is a block diagram showing a configuration of a video transmitting apparatus according to Embodiment 3 of the present invention;

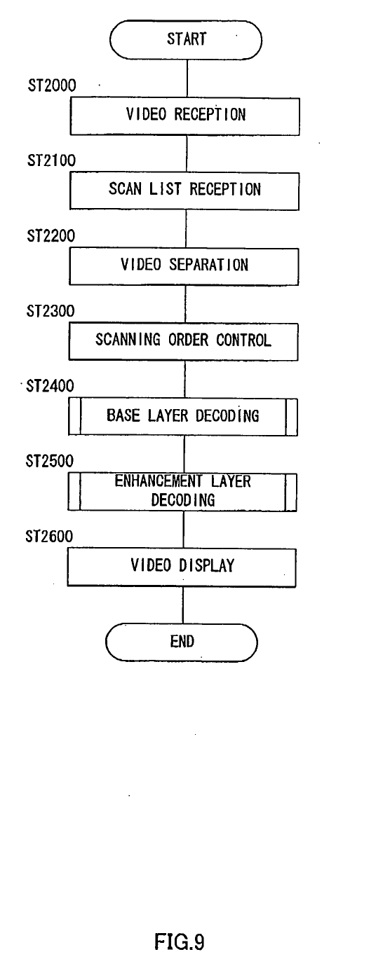

FIG. 9 is a block diagram showing a configuration of a video receiving apparatus according to Embodiment 3;

FIG. 20 is a flowchart showing the operation of the video transmitting apparatus of Embodiment 3;

FIG. 21 shows an example of block index information according to Embodiment 3;

FIG. 22A shows an example of a privacy mode scan list header;

FIG. 22B shows an example of a privacy mode scan matrix;

FIG. 23A shows an example of a designated privacy mode scan list header;

FIG. 23B shows an example of a designated privacy mode scan matrix; and

FIG. 24 is a flowchart showing the operation of the video receiving apparatus of Embodiment 3.

### DESCRIPTION OF THE PREFERRED EMBODIMENT

Embodiments of the present invention will be described below with reference to the accompanying drawings.

An outline of the present embodiment is to scan inputted images (or residual image signals generated from the difference between the inputted images and the reference image, determined through motion compensation prediction coding) in a privacy mode scanning order, which is different from a normal mode scanning order, and transmit a scan list that indicates the privacy mode scanning order to a user with authority to play the inputted video. Now, embodiments of the present invention will be described below in detail with reference to the accompanying drawings.

A case will be described here with this embodiment where MPEG-4 FGS is employed for the coding method of inputted video. Video data coded by MPEG-4 FGS is formed with (a) a base layer, which refers to a motion image stream that can be decoded individually, and (b) an enhancement layer, which refers to a motion image stream provided to improve the quality of decoded motion images in the base layer. With the base layer alone, despite the advantage that the transmission bandwidth can be minimized, video data can be obtained only in low quality. However, by transmitting and combining the enhancement layer in accordance with the available bandwidth, it becomes possible to obtain video data in improved quality and degree of freedom.

The video coding scheme to apply to the present invention is not limited to MPEG-4 FGS that utilizes DCT coding, and any video coding scheme is applicable as long as the video coding scheme orthogonal-transforms and quantizes inputted images and scans the quantized, orthogonal-transformed coefficients and encodes the inputted video, such as various coding schemes utilizing wavelet coding.

### Embodiment 1

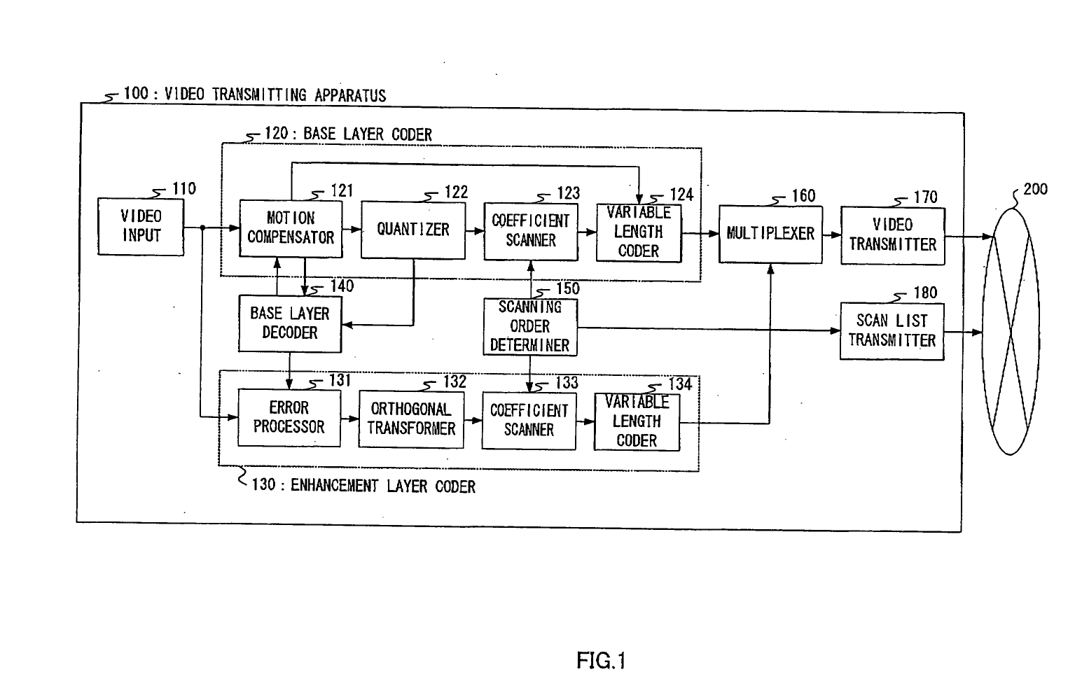

FIG. 1 is a block diagram showing the configuration of the video transmitting apparatus according to Embodiment 1 of the present invention. Video transmitting apparatus 100 shown in FIG. 1 has video input 110, base layer coder 120, enhancement layer coder 130, base layer decoder 140, scanning order determiner 150, multiplexer 160, video transmitter 170, and scan list transmitter 180.

Video input 110 receives video as input by means of imaging devices such as surveillance cameras, and the images making up the inputted video are outputted to base layer coder 120 and enhancement layer coder 130 one by one.

Base layer coder 120 generates a base layer video stream utilizing the images inputted from video input 110. To be more specific, base layer coder 120 has motion compensator 121, quantizer 122, coefficient scanner 123, and variable length coder 124. These components implement the following operations.

Motion compensator 121 examines the inputted images from video input 110 and the decoded image of the base layer outputted from base layer decoder 140 (hereinafter “reference image”), and finds the location where the correlation between these images is the highest. Thereupon, motion compensator 121 finds the location of the highest correlation in macro-block units consisting of 16×16 pixels. In addition, motion compensator 121 calculates a vector (hereinafter “motion vector”) to indicate the relative position of the location of the highest correlation and outputs the result to variable length coder 124. Moreover, motion compensator 121 finds differences in pixel units at the location of the highest correlation and thereby generates residual images and outputs the results to quantizer 122.

Incidentally, motion compensator 121 does not implement the above processings on the first inputted image upon start of coding processing and the inputted images at predetermined intervals, and, in such case, outputs the inputted images as they are, to quantizer 122.

Quantizer 122 applies the DCT transform, which is a variation of orthogonal transform, to the residual images outputted from motion compensator 121 (or the input images unchanged) and then replaces the coefficients obtained, with the quotients (hereinafter “orthogonal transform coefficients”) obtained by dividing these coefficients by a quantization value. Thereupon quantizer 122 DCT-transforms the residual images (or the input images unchanged) in block units consisting of 8×8 pixels.

Incidentally, quantizer 122 may perform the orthogonal transform of the residual images utilizing the wavelet transform instead of the DCT transform.

Coefficient scanner 123 scans the orthogonal transform coefficients outputted from quantizer 122 in the scanning order specified by scanning order determiner 150 and outputs the results sequentially to variable length coder 124. To be more specific, coefficient scanner 123 scans the orthogonal transform coefficients in the normal mode scanning order or in the privacy mode scanning order. These scanning orders will be later described in details.

Variable length coder 124 applies variable length coding processing to the motion vectors outputted from motion compensator 121 and the orthogonal transform coefficients outputted from coefficient scanner 123, utilizing a variable length code table, and outputs the base layer video stream obtained, to multiplexer 160. Similar to the above-descried scanning orders, variable length coder 124 may execute the variable length coding utilizing either the normal mode variable length code table or the privacy mode variable length code table. The privacy mode variable length code table is used only with respect to the orthogonal transform coefficients scanned in coefficient scanner 123 in the privacy mode scanning order.

Enhancement layer coder 130 generates the enhancement layer video stream utilizing the inputted images from video input 110. To be more specific, enhancement layer coder 130 has error processor 131, orthogonal transformer 132, coefficient scanner 133, and variable length coder 134. These components implement the following operations.

Error processor 131 applies error processing to the input images from video input 110 and the reference image outputted from base layer coder 140, and generates and outputs to orthogonal transformer 132 the residual images.

Orthogonal transformer 132 DCT-transforms the residual images outputted from error processor 131 in block units and outputs the orthogonal transform coefficients to coefficient scanner 133.

When the orthogonal transform coefficients outputted from orthogonal transformer 132 are represented in binary expression, coefficient scanner 133 makes the bits at the same bit position (i.e. bit plane) the processing unit in each block and scans the coefficients accordingly, and outputs the results sequentially to variable length coder 134. Similar to coefficient scanner 123 described above, coefficient scanner 133 scans the orthogonal transform coefficients in the normal mode scanning order or in the privacy mode scanning order. These scanning orders will be later explained in details.

Variable length coder 134 applies variable length coding processing to the orthogonal transform coefficients outputted from coefficient scanner 133 on a per bit plane basis, utilizing a variable length code table, and outputs the enhancement layer video stream obtained, to multiplexer 160. Incidentally, similar to the above-described scanning orders, variable length coder 134 may execute the variable length coding processing utilizing either the normal mode variable length code table or the privacy mode variable length code table. The privacy mode variable length table is used only with respect to the orthogonal transform coefficients scanned in coefficient scanner 133 in the privacy mode scanning order.

Base layer coder 140 applies dequantization and inverse orthogonal transform processing to the orthogonal transform coefficients outputted from quantizer 122 and decodes the residual images. In addition, base layer decoder 140 utilizes the previous decoded image and the motion vector outputted from motion compensator 121 and executes adding processing of the reference image used in motion compensator 121 and the residual image, and thereby generates the present decoded image.

Scanning order determiner 150 determines which one of the normal mode scanning order and the privacy mode scanning order to use to scan the base layer and enhancement layer, and, when implementing the scanning in the normal mode, directs this to coefficient scanner 123 and coefficient scanner 133.

In addition, when implementing the privacy mode scanning, scanning order determiner 150 determines the privacy mode scanning orders for the base layer and the enhancement layer respectively, generates scan lists indicating the scanning orders of the base layer and the enhancement layer respectively, outputs the lists to the coefficient scanner 123 and coefficient scanner 133 respectively, and outputs the both lists of the scanning orders of the base layer and the enhancement layer to scanning order list transmitter 180. Here the normal mode scanning may employ ZIGZAG scanning, set forth in MPEG-4 video coding standard (ISO/IEC 14496-2). As for the privacy scanning order, scanning order determiner 150 determiners, for example, random scanning orders. However, as will be described later, the normal mode scanning order has only to have regularity like ZIGZAG scanning. For example, when processing an interlace image, the alternate scanning, set forth in the MPEG-4 video coding standard (ISO/IEC 14496-2) is also included that changes the scanning order regularly in a certain pattern for improved coding efficiency. By contrast with this, the privacy mode scanning order refers to random scanning orders that have no regularity and such scanning orders that set no rules between the coding end and the decoding end and that make correct decoding impossible unless the coding end reports the scanning pattern to the decoding end.

Multiplexer 160 multiplexes the base layer video stream outputted from variable length coder 124 and the enhancement layer video stream outputted from variable length coder 134, and thereby generates a single video stream.

Video transmitter 170 transmits the video stream generated in the multiplexer 160 to the user via network 200.

Scan list transmitter 180 transmits the scan lists of the base layer and the enhancement layer generated by the scanning order determiner 150 only to specific users via network 200. The “specific users” here refer to users having the authority to decode the image scanned in the privacy mode. Incidentally, scan list transmitter 180 may encrypt the scan lists and then transmit these lists. The encryption of the scan lists may employ any method, including the shared key encryption method that utilizes a secret key shared with a specific user or the public key encryption method that utilizes the public key of a specific user.

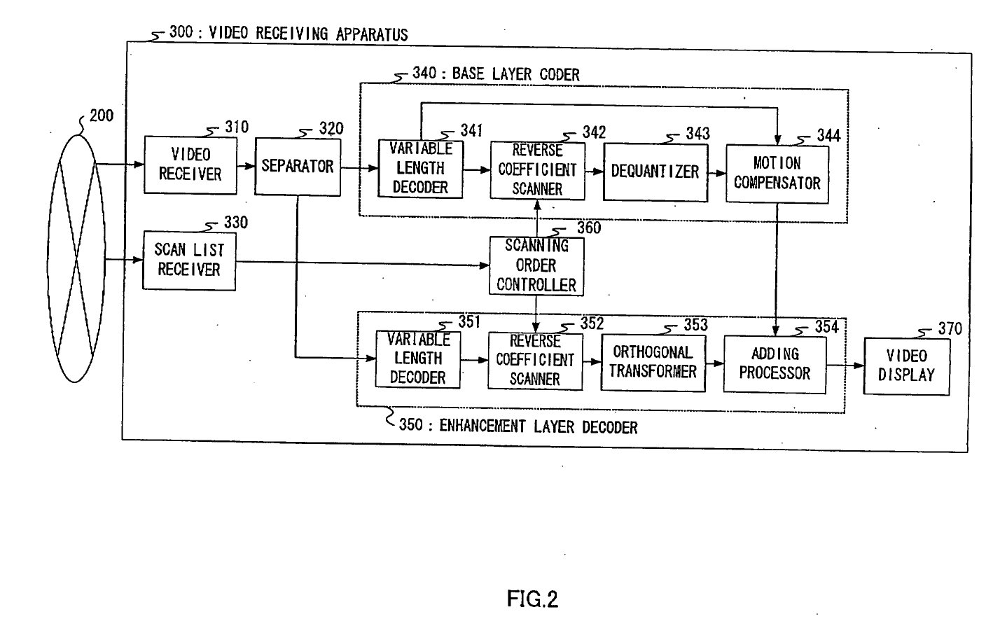

FIG. 2 is a block diagram showing a configuration of the video receiving apparatus according to Embodiment 1. Video receiving apparatus 300 shown in FIG. 2 has video receiver 310, separator 320, scan list receiver 330, base layer decoder 340, enhancement layer decoder 350, scanning order controller 360, and video display 370.

Video receiver 310 receives the video stream from video transmitting apparatus 100 via network 200 and outputs the video stream to separator 320.

Separator 320 detects the start code in the base layer and the enhancement layer in the video stream and thereby separates the video stream into the individual streams of the base layer and enhancement layer.

Scan list receiver 330 receives the scan lists transmitted from video transmitting apparatus 100 and outputs the lists to scanning order controller 360. If a certain time passes without receiving any scan lists scan list receiver 330 outputs information representing “SCAN LIST OFF” to scanning order controller 360.

Base layer decoder 340 generates the decoded images of the base layer from the base layer video stream outputted from separator 320. To be more specific, base layer decoder 340 has variable length decoder 341, reverse coefficient scanner 342, dequantizer 343, and motion compensator 344. These components implement the following operations.

Variable length decoder 341 subjects the base layer video stream to variable length decoding and thereby decodes the orthogonal transform coefficients and motion vectors. In addition, variable length decoder 341 outputs the orthogonal transform coefficients to reverse coefficient scanner 342 and the motion vectors to motion compensator 344. If variable length coder 124 of video transmitting apparatus distinguishes between the normal mode variable length code table and the privacy mode variable length code table and uses these tables accordingly, variable length decoder 341, like variable length decoder 124, uses the normal mode variable length code table and the privacy mode variable length code table.

Reverse coefficient scanner 342 reverse scans the orthogonal transform coefficients outputted form variable length decoder 341 in the scanning order indicated by scanning order controller 360 and outputs the result to dequantizer 343. To be more specific, reverse coefficient scanner 342 reverse scans the orthogonal transform coefficients in the normal mode scanning order or in the privacy mode scanning order. That is, reverse coefficient scanner 342 implements the reverse scanning in the privacy mode scanning order when a scan list is inputted from scanning order controller 360, and implements the reverse scanning in the normal mode scanning order when no such scan list is inputted.

Dequantizer 343 applies dequantization and inverse orthogonal transform processing to the orthogonal transform coefficients outputted from reverse coefficient scanner 342 and decodes the residual images.

Motion compensator 344 uses the residual images outputted from dequantizer 343, the motion vectors outputted from variable length decoder 341, and the previous decoded images, and generates new decoded images.

Enhancement layer decoder 350 generates the decoded images of the enhancement layer from the enhancement layer video stream outputted from separator 320. To be more specific, enhancement layer decoder 350 has variable length decoder 351, reverse coefficient scanner 352, orthogonal transformer 353, and adding processor 354. These components implement the following operations.

Variable length decoder 351 applies variable length decoding processing to the enhancement layer video stream and thereby decodes the orthogonal transform coefficients, scanned on a per bit plane basis in block units, and outputs these orthogonal transform coefficients to reverse coefficient scanner 352. If variable length coder 134 of video transmitting apparatus 100 distinguishes between the normal mode variable length code table and the privacy mode variable length code table and uses these tables accordingly, variable length decoder 351, like variable length decoder 134, uses the normal mode variable length code table and the privacy mode variable length code table.

Reverse coefficient scanner 352 reverse scans the orthogonal transform coefficients outputted from variable length decoder 351 on a per bit plane basis in the scanning order indicated by the scanning order controller 360, and outputs the result to orthogonal transformer 353. To be more specific, reverse coefficient scanner 352 reverse scans the orthogonal transform coefficients in the normal mode scanning order or in the privacy mode scanning order. That is, reverse coefficient scanner 352 implements the reverse scanning in the privacy mode scanning order when a scan list is inputted from scanning order controller 360, and implements the reverse scanning in the normal mode scanning order when no such scan list is inputted.

Orthogonal transformer 353 applies inverse DCT transform to the orthogonal transform coefficients outputted from reverse coefficient scanner 352 and decodes the residual images.

Adding processor 354 performs adding processing of the base layer decoded images outputted from motion compensator 344 and the residual images outputted from orthogonal transformer 353 and outputs the decoded images obtained, to video display 370.

When a scan list is inputted from scan list receiver 330, scanning order controller 360 understands the content of the scan list header. If the scan list is one of the base layer, the list will be outputted to reverse coefficient scanner 342. If the scan list is one of the enhancement layer, the list will be outputted to reverse coefficient scanner 352.

Upon receiving as an input the information representing “SCAN LIST OFF” from scan list receiver 330, scanning order controller 360, if there is no scan list for the base layer, outputs information representing “NO SCANT LIST” to reverse coefficient scanner 342, and, if there is no scan list for the enhancement layer, outputs the information representing “NO SCAN LIST” to reverse coefficient scanner 352.

Video display 370 displays the decoded images on, for example, a display device.

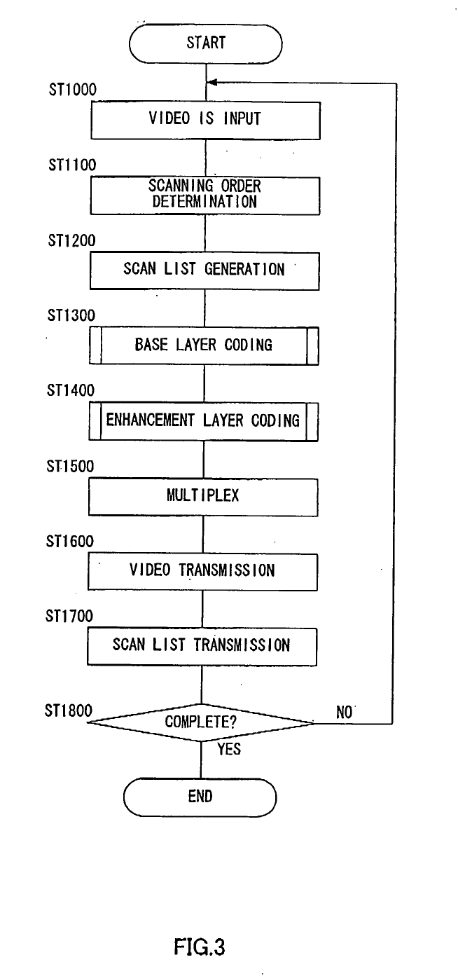

Next, the operation of video transmitting apparatus 100 having the above configuration will be described with reference to the flowchart of FIG. 3. In video transmitting apparatus 100, the operation in the flowchart in FIG. 3 is memorized in a memory device (not shown: e.g., ROM or flash memory) in the form of a control program and is controlled by a CPU (not shown).

First, video input 110 inputs video (ST1000). To be more specific, video input 110 having imaging devices such as surveillance cameras inputs video, and the images making up the inputted video are outputted to motion compensator 121 and error processor 131 one image after another.

Then, scanning order determiner 150 determines the scanning orders of the orthogonal transform coefficients for the base layer and the enhancement layer, providing the layers with respective scanning orders (ST1100). The scanning orders determined here are different from normal mode scanning orders (e.g., ZIGZAG scanning order) and employ, for example, random orders. As a result, the receiving end to receive the video stream is unable to implement reverse scanning accurately without information about the scanning orders and is unable to obtain the decoded images.

Scanning orders are determined in such manners only when scanning is implemented in the privacy mode. That is, to make the decoded images available only to specific users, for example, employing random scanning orders makes a common user, or a non-specific user, unable to decode the video stream accurately, thereby making possible privacy protection. It is also possible to divide an input image into multiple blocks and determine varying scanning orders for the individual blocks. In this case, privacy protection is implemented even stronger.

On the other hand, when scanning is implemented in the normal mode, the scanning order is not determined. Instead, scanning order determiner 150 reports that the scanning is going to be performed in the normal mode to coefficient scanner 123 and coefficient scanner 133.

When the scanning orders are determined, scanning order determiner 150 generates scan lists that respectively represents the scanning orders of the base layer and the enhancement layer (ST1200), and outputs the both scan lists to scan list transmitter 180, while also outputting the scan list of the base layer to coefficient scanner 123 and the scan list of the enhancement layer to coefficient scanner 133. If varying scanning orders are determined for the individual blocks, multiple scan lists corresponding respectively to these scanning orders are generated.

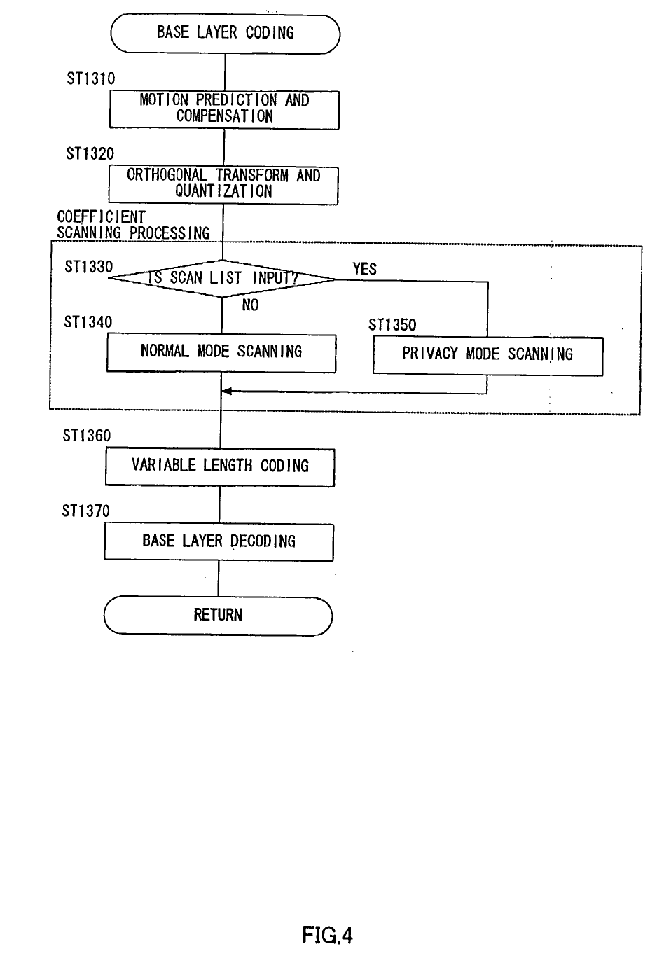

When the scan lists are generated, base layer coder 120 encode the base layer, and thereupon the base layer video stream is generated (ST1300). To be more specific, processings such as shown in the flowchart in FIG. 4 are executed.

That is, motion compensator 121 uses an input image and a previous decoded image outputted from base layer decoder 140 (i.e. reference image) and finds the location where the correlation between the input image and the reference image is the highest (“motion prediction processing”). Moreover, with the vector indicating this position and through error processing of the input image and the reference image in pixel units, the residual image is obtained (“motion compensation processing”) (ST1310). The residual image obtained in ST1310 is outputted to quantizer 122 and the motion vector is outputted to variable length coder 124.

Quantizer 122 executes the DCT transform of the residual image in block units and thereby quantizes the residual image (ST1320). The orthogonal transform coefficients after the quantization processing are outputted to coefficient scanner 123 and base layer decoder 140. As mentioned earlier, the orthogonal transform in quantizer 122 is by no means limited to the DCT transform and can be other methods such as the Wavelet transform.

When the orthogonal transform coefficients after the quantization processing are outputted to coefficient scanner 123, coefficient scanning processing is implemented, which is shown in dot lines in the flow chart of FIG. 4. That is, coefficient scanner 123 determines whether or not a scan list has been inputted (ST1330). As a result of this determination, if a certain time passes without a scan list inputted, or if a report is received from scanning order determiner 150 that the scanning is going to be implemented in the normal mode, coefficient scanner 123 implements the scanning in the normal mode, employing, for example, ZIGZAG scanning orders and such (ST1340). The orthogonal transform coefficients obtained by the scanning are outputted sequentially to variable length coder 124. On the other hand, the determination in ST1330 produces a result that a scan list has been inputted, coefficient scanner 123 implements the scanning in the privacy mode in the scanning order indicated by the scan list (ST1350). The orthogonal transform coefficients obtained by the scanning are sequentially outputted to variable length coder 124.

Variable length coder 124 applies variable length coding processing to motion vectors outputted from motion compensator 121 and the orthogonal transform coefficients outputted from coefficient scanner 123 (ST1360), and outputs the base layer video stream obtained, to multiplexer 160. If the scanning is implemented in the privacy mode in ST1350, the variable length coding may be performed utilizing a privacy mode variable length code table. By this means, it is possible to prevent decrease in coding efficiency due to use of the normal mode variable length code table that is optimized for ZIGZAG scanning.

Thus, base layer coder 120 generates the base layer video stream, and base layer decoder 140 generates the decoded images of the base layer (ST1370). That is, base layer decoder 140 executes the inverse quantization and inverse orthogonal transform of the orthogonal transform coefficients outputted from quantizer 122, and thereby decodes the residual images. In addition, adding processing is executed utilizing the reference image and the motion vectors used in motion compensator 121, and new decoded images are generated. These decoded images are outputted to motion compensator 121 and error processor 131.

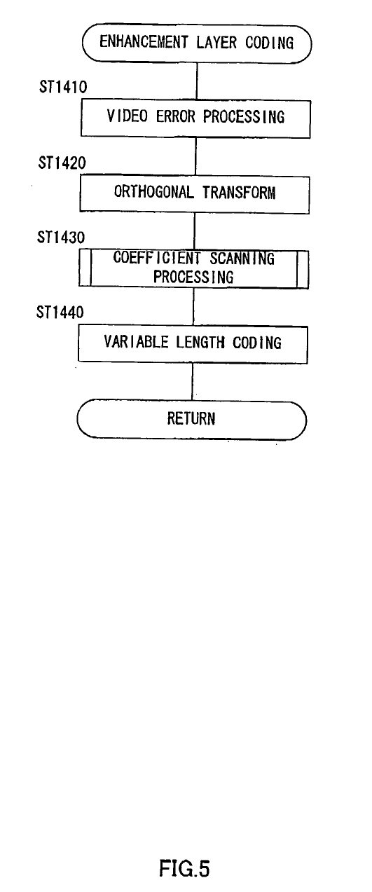

Referring again to the flowchart of FIG. 3, the coding of the base layer is executed in ST1300 as described above, and, at the same time, enhancement layer coder 130 encodes the enhancement layer and generates the enhancement layer video stream (ST1400). To be more specific, processings such as shown in the flowchart of FIG. 5 are executed.

Error processor 131 executes error processing of the input images and the decoded images of the base layer outputted from base layer decoder 140 (ST1410), and outputs the residual images obtained to orthogonal transformer 132.

Then, orthogonal transformer 132 executes the DCT transform of the residual images in block units (ST1420) and outputs the orthogonal transform coefficients to coefficient scanner 133.

When the orthogonal transform coefficients are outputted to coefficient scanner 133, the same or equivalent processings as the coefficient scanning processing of ST1330 through ST1350 in the above-mentioned flowchart of FIG. 4, circled by dot lines, are implemented (ST1430).

That is, coefficient scanner 133 determines whether or not a scan list has been inputted, and, if no scan list has been inputted, the scanning is implemented in the normal mode. On the other hand, when a scan list has been inputted, the scanning is implemented in the privacy mode, utilizing the scan list, in which the bits that are present at the same bit position (i.e. bit plane) when the orthogonal transform coefficients are represented in binary expression are the processing unit in the blocks, and the orthogonal transform coefficients obtained are sequentially outputted to variable length coder 134.

Variable length coder 134 applies variable length coding processing to the orthogonal transform coefficients outputted from coefficient scanner 133 on a per bit plane basis (ST1440), and outputs the video stream of the enhancement layer obtained to multiplexer 160. If the scanning is implemented in the privacy mode in ST1430, the variable length coding may be performed utilizing a privacy mode variable length code table.

Referring to the flowchart of FIG. 3, if the coding of the enhancement layer is implemented in the above-described manner in ST1400, multiplexer 160 multiplexes the base layer video stream outputted from variable length coder 124 and the enhancement layer video stream outputted from variable length coder 134 (ST1500) and outputs the video stream obtained to video transmitter 170.

Then, video transmitter 170 transmits the video stream to network 200 (ST1600). Thereafter, if the scanning is implemented in the privacy mode in the coding operation in ST1300 and ST1400, scan list transmitter 180 transmits the scan lists for the base layer and the enhancement layer to specific users via network 200 (ST1700). This transmission of the scan lists is implemented apart from the video stream transmission. That is, for example, the scan lists are transmitted at different timings, utilizing different channels, and so on.

Incidentally, it is certainly possible to transmit the scan lists of the base layer and the enhancement layer individually to different users. That is, for example, assuming that a remote monitoring system is implemented with surveillance cameras, it is possible to transmit the scan list of the base layer, which is necessary for low-quality playback, to the administrator and common users, and transmit the scan list of the enhancement layer, which is necessary for high-quality playback, to the administrator alone. By this means, the administrator alone is allowed to monitor high quality video of object images such as people. On the other hand, common users besides the administrator are allowed only low quality playback, so that to some extent privacy protection of object images such as distinct people's face is possible. When the video stream and the scan lists are inputted, a determination is made as to whether the requirements for terminating the processing are fulfilled (ST1800). If these requirements are fulfilled, the process will be terminated, and, if these requirements are not fulfilled, the process repeats from ST1000. Next, the scanning order determination implemented in the operation of above-mentioned video transmitting apparatus 100 will be explained in details with examples.

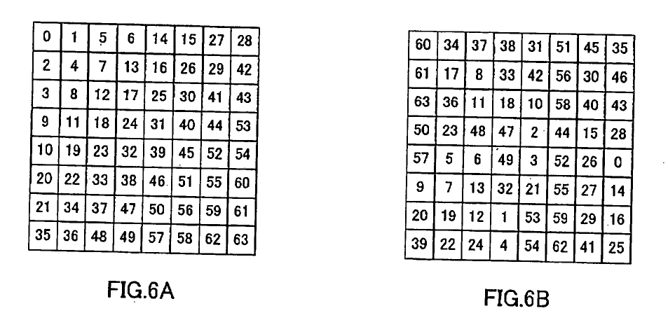

FIG. 6 shows an example of scanning orders used in coefficient scanner 123 and coefficient scanner 133. The figure shows the scanning order in a single block consisting of 8×8 pixels, in which the orthogonal transform coefficients are scanned sequentially from ones corresponding to pixels of small numbers. Furthermore, FIG. 6A shows an example of normal mode scanning order and FIG. 6B shows an example of privacy mode scanning order.

The example of normal mode scanning order shown in FIG. 6A represents the scanning order in ZIGZAG scanning, set forth in MPEG-4 video coding standard (ISO/IEC 14496-2), and the figure makes it clear that scanning is implemented in a zigzag pattern, from a pixel on the higher left position to a pixel on the lower right position. Incidentally, as described above, the normal mode scanning order includes not only the above ZIGZAG scanning but also alternate scanning, which is intended for improved coding efficiency of interlaced sequences.

On the other hand, the scanning order shown as FIG. 6B has no regularity, and it is obvious that the scanning is implemented in a random order. In the privacy mode, scanning is implemented in such random orders, and so the decoding end is unable to decode video accurately without implementing reverse scanning in the same scanning orders. In other words, to implement correct video decoding in the privacy mode, it is necessary to know the scanning order in the privacy mode, because this scanning order is the key to video stream decoding.

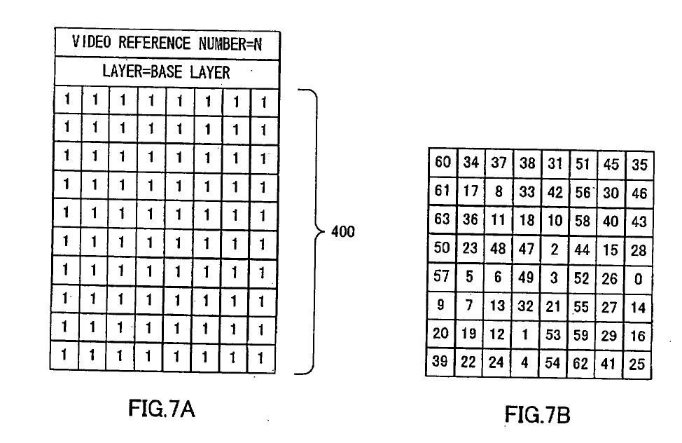

Scanning order determiner 150 generates scan lists as such keys. FIG. 7 shows an example of a scan list. FIG. 7A represents the scan list header and FIG. 7B represents the scan matrix.

The scan list header shown as FIG. 7A contains three types of information: (1) the reference number of the image to which the scan matrix is applied (“N” in the figure); (2) the layer to which the scan matrix is applied (the base layer in the figure); and (3) block map 400 indicating the blocks to which the scan matrix is applied. Block map 400 has a grid structure containing the same number of components as all the blocks in the image, in which the scan matrix is applied to the blocks corresponding to the components with the value of 1.

The scan matrix shown as FIG. 7B represents a scanning order of orthogonal transform coefficients corresponding respectively to the 8×8 pixels in the blocks. Consequently, from the information in the scan list header in FIG. 7A, for the base layer of the image having the reference number N, scanning is implemented making the scanning order in all the blocks as shown in the scan matrix of FIG. 7B. Although not shown in this figure, the scan list of the enhancement layer has a different scan matrix from the scan matrix shown as FIG. 7B.

The data format of the scan list is by no means limited to the one shown in FIG. 7, and any data format is fine as long as scanning orders can be correctly described on a per block basis. Moreover, it is possible to associate a single image and multiple scan lists, and, by this means, when individual blocks employ different scanning orders, it is possible to make multiple scan lists that have individual scan matrixes corresponding respectively to the individual blocks. In this case, reference is made to block map 400 in each scan list, and the scan matrix of a scan list is applied to the blocks showing the value 1 in the block map.

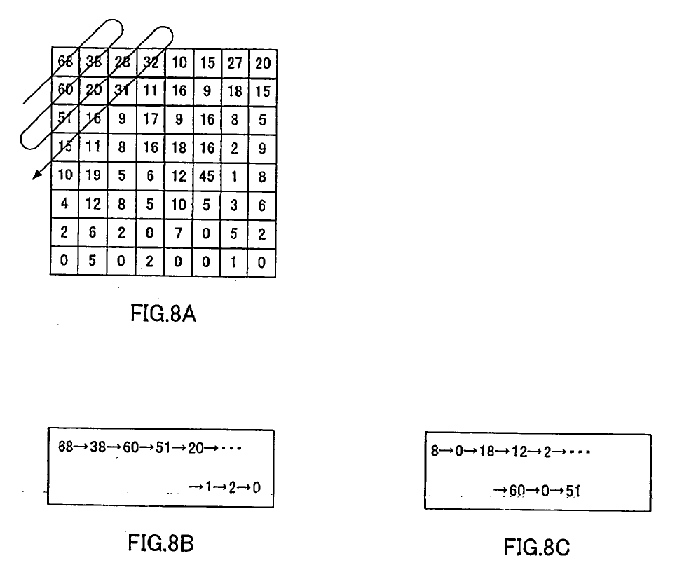

If, for example, the blocks shown as FIG. 8A are scanned utilizing such scan lists, the orthogonal transform coefficients are scanned in the order shown in FIG. 8B (68, 38, 60 . . . ) when the scanning is implemented in the normal mode (e.g. zigzag scanning). On the other hand, if the scanning is implemented in the privacy mode utilizing the scan list shown in FIG. 7, the orthogonal transform coefficients are scanned in the order shown in FIG. 8C (8, 0, 18, . . . ).

Next, the operation of video receiving apparatus 300 of the present embodiment will be described with reference to the flowchart shown in FIG. 9. In video transmitting apparatus 300, the operation in the flowchart in FIG. 9 is memorized in a memory device (not shown: e.g., ROM and flash memory) in the form of a control program and is controlled by a CPU (not shown).

First, video receiver 310 receive the video stream from network 200 (ST2000) and outputs the video stream to separator 320. In addition, scan list receiver 330 receives the scan lists from network 200 (ST2100) and outputs the lists to scanning order controller 360. If a certain time passes without the scan lists received, scan list receiver 330 outputs information representing “SCAN LIST OFF” to scanning order controller 360. If encryption processing is executed prior to the transmission of the scan lists, scan list receiver 330 undoes the encryption. If multiple scan lists are received, these scan lists are all outputted to scanning order controller 360.

Separator 320 detects the start code in the base layer and the enhancement layer in the video stream outputted from video receiver 310, thereby separates the video stream into the base layer video stream and the enhancement layer video stream (ST2200), and outputs the base layer video stream to base layer decoder 340 and the enhancement layer video stream to enhancement layer decoder 350.

Then, scanning order controller 360 outputs the scan list of the base layer to reverse coefficient scanner 342 and the scan list of the enhancement layer to reverse coefficient scanner 352. When the information representing “SCAN LIST OFF” about the base layer is inputted from scan list receiver 330 to scanning order controller 360, the information representing “NO SCAN LIST” is inputted in scan reverse coefficient scanner 342. When the information representing “SCAN LIST OFF” about the enhancement layer is inputted, information representing “NO SCAN LIST” is inputted to reverse coefficient scanner 352 (ST2300).

This enables reverse coefficient scanner 342 and reverse coefficient scanner 352 to implement the reverse scanning respectively in the normal mode or in the privacy mode.

In other words, when the information representing “NO SCAN LIST” is outputted from scanning order controller 360, the reverse scanning is implemented in the normal mode, and, when the scan lists are inputted from scanning order controller 360, the reverse scanning is implemented in the privacy mode in accordance with this scan lists.

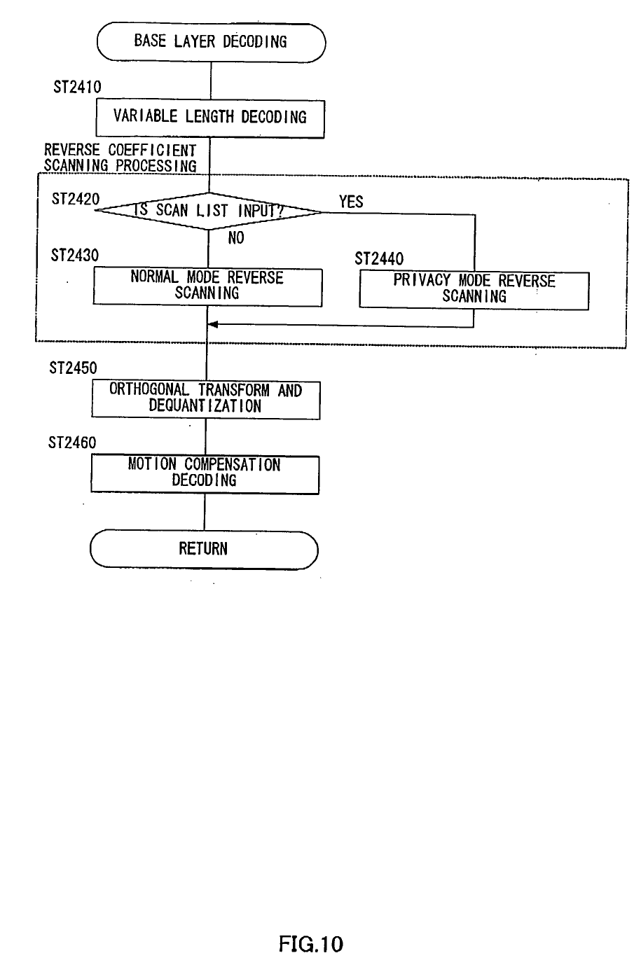

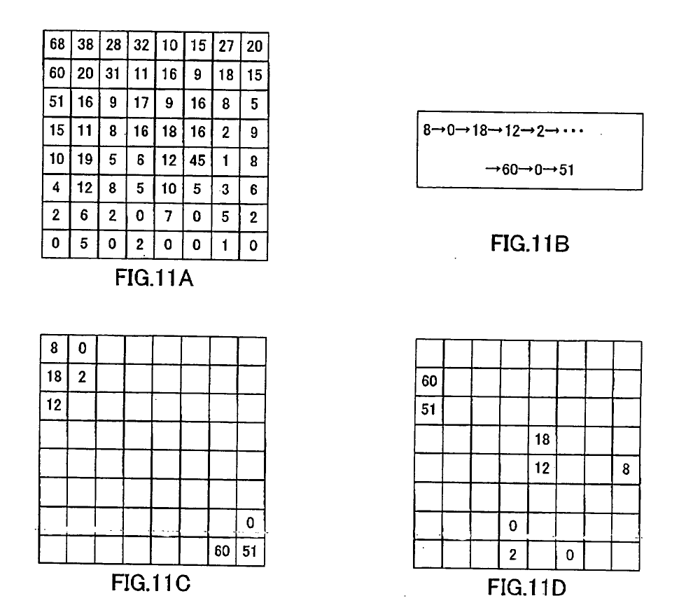

When scanning order control is implemented as described above, base layer decoder 340 decodes the base layer and generates the decoded images of the base layer (ST2400). To be more specific, processings such as shown in the flowchart in FIG. 10 are executed.

That is, variable length decoder 341 applies variable length decoding to the base layer video stream utilizing the variable length code table and obtains orthogonal transform coefficients and motion vectors in block units (ST2410). The orthogonal transform coefficients obtained in ST2410 are outputted to reverse coefficient scanner 342 and the motion vectors are outputted to motion compensator 344. If the base layer video stream is scanned in the privacy mode, the variable length coding may be performed utilizing a privacy mode variable length code table.

When the orthogonal transform coefficients are outputted to reverse coefficient scanner 342, reverse coefficient scanning processing is implemented, which is shown in dot lines in the flow chart of FIG. 10. That is, reverse coefficient scanner 342 determines whether or not a scan list has been inputted (ST2420). If, as a result of this determination, no scan list has been inputted and instead the information representing “NO SCAN LIST” has been inputted, reverse coefficient scanner 342 implements the reverse scanning in the normal mode in block units (ST2430). The orthogonal transform coefficients obtained though the reverse scanning are outputted to dequantizer 343. On the other hand, if as a result of determination in ST2420 a scan list has been inputted, reverse coefficient scanner 342, privacy mode scanning is implements the reverse scanning in the privacy mode in block units in the scanning order represented by this scan list (ST2440). The orthogonal transform coefficients obtained through the reverse scanning are outputted to dequantizer 343. In case the blocks are scanned in respective scanning orders, the reverse scanning of the orthogonal transform coefficients is implemented with reference to multiple scan lists corresponding respectively to the individual blocks.

FIG. 11 shows an example of the operation of reverse coefficient scanning. When video transmitting apparatus 100 of the present embodiment scans the orthogonal transform coefficients of the blocks shown as FIG. 11A in the privacy mode, the coefficients are obtained in the order shown in FIG. 11B. When these coefficients shown in FIG. 11B are reverse-scanned in the normal mode, orthogonal transform coefficients such as shown in FIG. 11C are obtained. If the coefficients are reverse scanned in the privacy mode, orthogonal transform coefficients such as shown in FIG. 11D are obtained. Incidentally, in FIG. 11C and FIG. 11D, some of the orthogonal coefficients are omitted for ease of explanation.

Comparison of FIG. 11C and FIG. 11D to FIG. 11A shows that the coefficients scanned in the privacy mode can be decoded back to the same orthogonal transform coefficients they were before the scanning in video transmitting apparatus 100 only when reverse-decoded in the privacy mode. In contrast, when coefficients scanned in the privacy mode are reverse-scanned in the normal mode, correct video deciding is obviously not possible.

Consequently, the video stream scanned in the privacy mode cannot be correctly decoded unless the scan list is received, so that confidentiality improves. Moreover, when a normal decoding apparatus is employed, generally, reverse scanning is implemented in normal mode scanning orders (e.g. ZIGZAG scanning order). This makes correct reverse scanning and correct decoding, so that confidentiality improves.

Dequantizer 343 executes the dequantization and inverse orthogonal transform processing of the orthogonal transform coefficients obtained through the above reverse scanning, and decodes the residual images (ST2450) Motion compensator 344 utilizes the residual images, the motion vectors, and the previous decoded image (i.e. reference image) and generates the decoded image of the base layer through the same operation as in base layer decoder 140 in video transmitting apparatus 100 (ST2460).

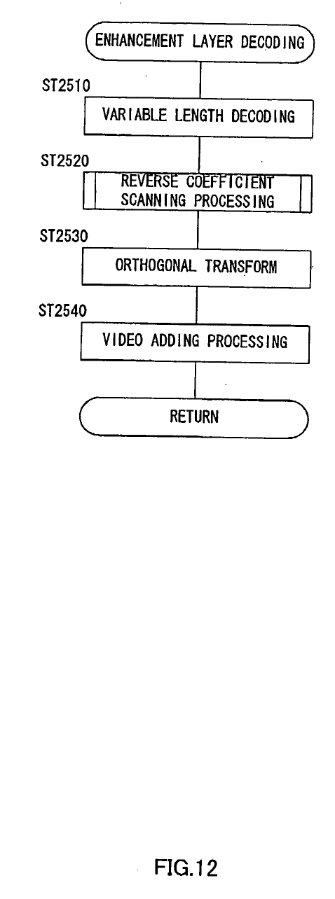

Referring again to the flowchart of FIG. 9, the decoding of the base layer is executed in ST2400 as described above and at the same time enhancement layer decoder 350 decodes the enhancement layer and generates the decoded images of the enhancement layer (ST2500). To be more specific, processings such as shown in the flowchart in FIG. 12 are executed.

Variable length decoder 351 applies variable length decoding processing to the enhancement layer video stream utilizing the variable length code table, thereby obtaining orthogonal transform coefficients scanned on a per bit plane basis in block units (ST2510). The orthogonal transform coefficients obtained in ST2510 are outputted to reverse coefficient scanner 352. If the enhancement layer video stream is scanned in the privacy mode, the variable length coding may be performed utilizing a privacy mode variable length code table.

When the orthogonal transform coefficients are outputted to reverse coefficient scanner 352, reverse coefficient scanning processing is implemented, which is shown in dot lines in the flowchart of FIG. 10. That is, coefficient scanner 352 determines whether or not a scan list has been inputted, and, if the information representing “NO SCAN LIST” has been inputted, the reverse scanning is implemented in the normal mode. When a scan list has been inputted, the reverse scanning is repeated several times in the privacy mode in the scanning order represented by the scan list, and the orthogonal transform coefficients of the individual bit planes are obtained in block units (ST2520). The orthogonal transform coefficients obtained by the reverse scanning are outputted to orthogonal transformer 353.

In this reverse scanning operation of the enhancement layer again, similar to the above-described reverse scanning operation of the base layer, correct video decoding is not possible unless the scan list of the privacy mode is received, so that confidentiality can be maintained. In other words, for high quality video playback, the scan list of the enhancement layer needs to be received.

The orthogonal transform coefficients obtained by the reverse scanning are subjected to the inverse DCT transform and thereupon the residual images are decoded (ST2530). Then, adding processor 354 performs adding processing of the decoded images of the base layer and the residual images outputted from orthogonal transformer 353 and generates the decoded image (ST2540). The decoded images are outputted to video display 370.

If in the adding processing of ST2540 one of the base layer and the enhancement layer is not decoded correctly, it is possible to skip the adding processing and output only the correctly decoded layer or the blue back images to video display 370.

Referring back to the flowchart of FIG. 9, if the above-described enhancement layer decoding is executed in ST2500, video display 370 displays the decoded images by means of a display device or the equivalent (ST2600).

Thus, according to the present embodiment, the video transmitting apparatus scans images in random scanning orders in the privacy mode and transmits a video stream, and transmits, besides the video stream, scan lists that indicate the scanning orders, to specific users alone. Consequently, only the video decoding apparatuses of the specific users who receive these scan lists are able to decode the video stream correctly. In contrast, common users who do not receive the scan lists are unable to decode the video stream correctly. As a result, it is possible to employ encryption processing and improve confidentiality of video subject to communication without increasing the processing load.

Moreover, according to the present embodiment, the base layer and the enhancement layer may be processed in respective privacy modes. This makes possible the kind of privacy management whereby common users are allowed only low quality playback of the base layer and specific users are allowed high quality playback that adds the enhancement layer.

Incidentally, although a case has been described with this embodiment where a privacy mode is set in respect to the base layer as well, it is certainly possible to scan the base layer in the normal mode alone. By this means, low quality playback is possible even when a conventional decoding apparatus is in use, so that a maximum number of users are able to view low quality video. Meanwhile, however, for high quality playback, the enhancement layer scanned in the privacy mode needs to be decoded correctly utilizing the scan list of the privacy mode. For example, assuming that a surveillance camera system is implemented, provided that only authorized specific users such as the administrator are allowed high quality playback and summary video from the surveillance cameras is disclosed to common users in low quality, the privacy of the object person, such as face area and so on, is protected while the surveillance cameras certainty improves the effectiveness of crime prevention.

In addition, in the layered coding scheme, it is possible to divide the enhancement layer into multiple blocks and transmit and play them.

Moreover, a number of types of layers exist in the enhancement layer, including the quality enhancement layer for SNR (Signal to Noise Ratio) improvement, the frame rate enhancement layer for frame rate improvement, and the resolution enhancement layer for resolution improvement. Now, it is certainly possible to set respective privacy modes for the multiple layers and transmit these layers to respective video receiving apparatuses. This makes it possible to implement video communications where the quality, frame rate, resolution, and the degree of resolution are managed adaptively in accordance with the viewing authority of individual receivers.

Although a case has been described with this embodiment where a scanning order is determined every time an image is inputted, the present invention is by no mean limited to this, for example, it is equally possible to determine a new scanning order on a regular basis. By this means, it is possible to reduce the processing load required in scanning order determination.

Although a case has been described with this embodiment where variable length coding is implemented utilizing a variable length code table, the present invention is by no means limited to this, and it is equally possible to report a privacy mode variable length code table to specific users alone and thereby make video playback not possible without receiving both the scan list and the variable length code table. As a result, the kind of video communications that assures higher levels of confidentiality is possible.

Although a case has been described with this embodiment where the video coding processing, transmission processing, reception processing, and video decoding processing are implemented in synch, the present invention is by no means limited to this, and it is equally possible to implement these processings asynchronously. That is, for example, it is equally possible to implement the video coding processing in advance and afterwards implement the transmission processing, reception processing, and decoding processing, or implement the video coding processing, transmission processing, and reception processing in advance and afterwards implement the video decoding processing.

### Embodiment 2

It is a feature of Embodiment 2 of the present invention that, upon determining the scanning order of orthogonal transform coefficients, scanning is not implemented in the privacy mode at times of unusual circumstances, such as when an alarm goes off, and common users without scan lists are allowed video playback.

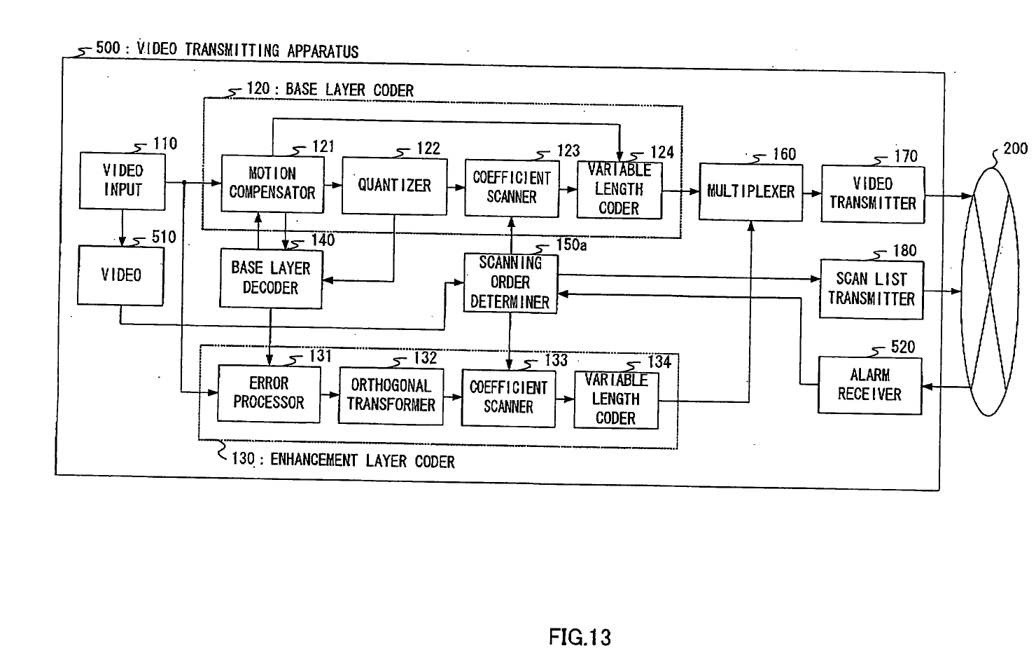

FIG. 13 is a block diagram showing the configuration of the video transmitting apparatus according to Embodiment 2 of the present invention. Parts in the video transmitting apparatus shown in the figure that are identical to those of the video transmitting apparatus shown in FIG. 1 are assigned the same reference numerals without further explanations. The video transmitting apparatus 500 shown in FIG. 13 has video input 110, base layer coder 120, enhancement layer coder 130, base layer decoder 140, scanning order determiner 150a, multiplexer 160, video transmitter 170, scan list transmitter 180, image recognizer 510, and alarm receiver 520.

Image recognizer 510 checks an input image outputted from video input 110 against registered images such as face images prestored in a database through image processing. Upon detecting an object in the input image that matches a registered image, image recognizer 510 outputs to scanning order determiner 150a three components of alarm information: an alarm signal (“ALARM”); the center coordinate of the detected object (“G”); and the size of the detected object (“S”).

Alarm receiver 520 receives the alarm information transmitted from video receiving apparatus 600 and other sensors (which will be described later), and outputs the alarm information to scanning order determiner 150a.

Only when the alarm information is not inputted from image recognizer 510 and alarm receiver 520, does scanning order determiner 150a implement the same operations as order determiner 150 of Embodiment 1. When the alarm information is inputted, scanning order determiner 150a determines that both the base layer and the enhancement layer will implement scanning in the normal mode, and will not determine privacy mode scanning orders and output scan lists.

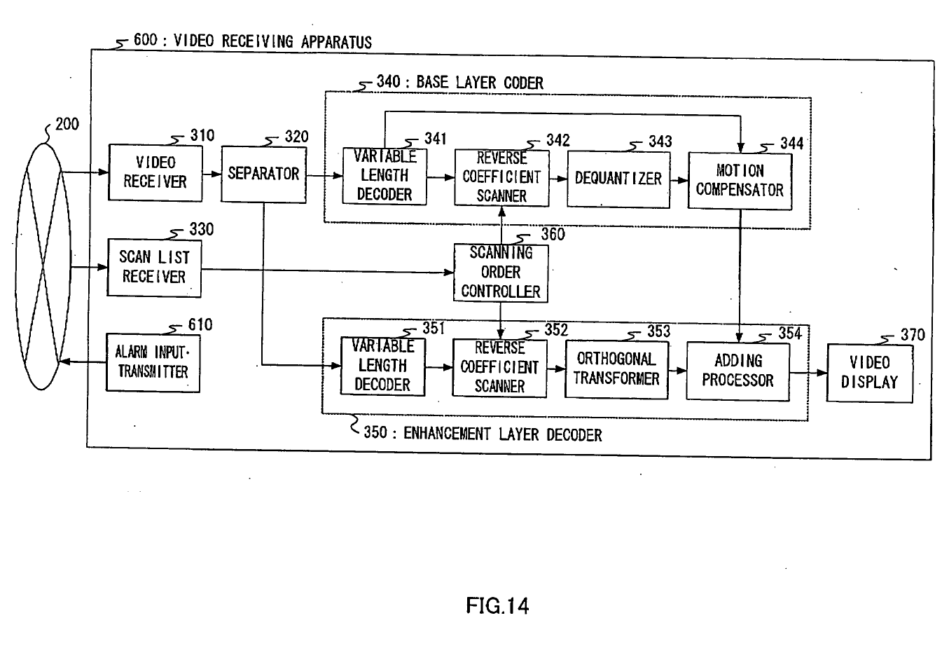

FIG. 14 is a block diagram showing the configuration of the video receiving apparatus according to Embodiment 2. Parts in the video receiving apparatus shown in the figure that are identical to those of the video receiving apparatus of FIG. 2 are assigned the same reference numerals without further explanations. Video receiving apparatus 600 shown in FIG. 14 has video receiver 310, separator 320, scan list receiver 330, base layer decoder 340, enhancement layer decoder 350, scanning order controller 360, video display 370, and alarm input/transmitter 610.

Alarm input/transmitter 610 receives an alarm request as an input from a user monitoring the video displayed on video display 370, and, upon accepting the alarm request as an input, transmits alarm information to video transmitting apparatus 500.

Alarm input/transmitter 610, upon receiving an alarm cancel request from the user, stops transmitting the alarm information.

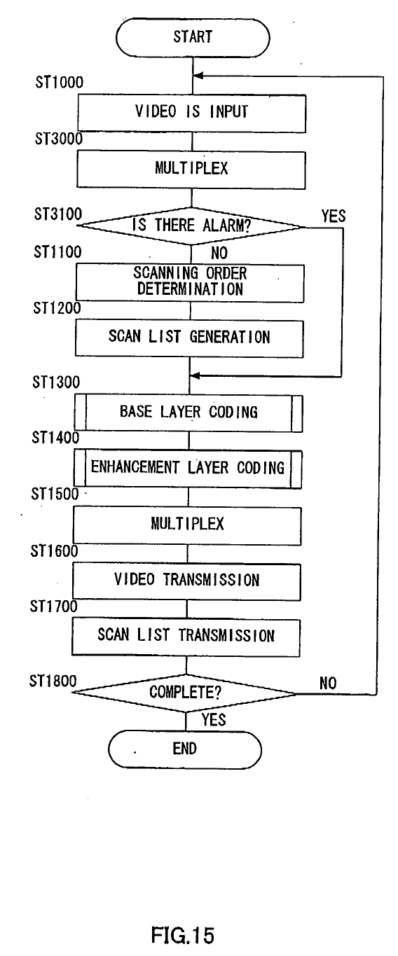

Next, the operation of video transmitting apparatus 500 having the above configuration will be described with reference to the flowchart of FIG. 15. In this flowchart, steps identical to those in the flowchart of FIG. 3 are assigned the same reference numerals without further explanations.

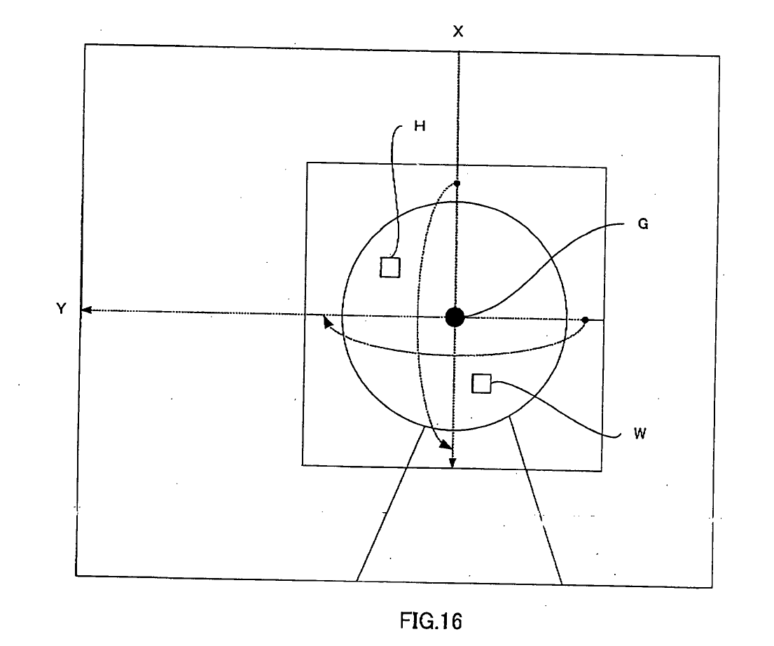

An input image outputted from video input 110 is outputted to image recognizer 510. Image recognizer 510 checks the input image against registered images prestored in a data base such as face images through image processing (ST3000). If as a result of this image recognition processing an object in the input image finds a matching registered image, as shown in FIG. 16, the center coordinate of the detected object (G (X, Y)) and the size of the detected object (W, H) are outputted to scanning order determiner 150a with the alarm signal (ALARM). Although only a square shape is shown in FIG. 16 as an example of a detected object, the number of detected objects is by no means limited to one, and it is equally possible to use various shapes such as circles and polygons.

Thus, while image recognizer 510 outputs the alarm information, alarm receiver 520 monitors the alarm signal (ALARM) transmitted from video receiving apparatus 600 and other sensors. When alarm receiver 520 receives the alarm signal (ALARM), the alarm information will be outputted to scanning order determiner 150a. Incidentally, the “other sensors” mentioned above refers to, for example, infrared sensors that are installed near surveillance cameras to detect unusual circumstances and transmit the alarm signal (ALARM) to video transmitting apparatus 500.

Then, scanning order determiner 150a determines whether or not the alarm information has been inputted (ST3100). If as a result of this determination alarm information has not been inputted, similar to Embodiment 1, scanning orders are determined in the normal mode or in the privacy mode, and, the scanning orders are determined in the privacy mode, scan lists are generated. On the other hand, if as a result of determination in ST3100 alarm information has been inputted, normal mode scanning is determined to be applied, unconditionally, to both the base layer and the enhancement layer, and the determination of privacy mode scanning orders and generation of scan lists are not implemented.

By this means, when alarm information signifying unusual circumstances is inputted into scanning order determiner 150a, scanning is executed in the normal mode. As a result, common users not having authority to implement high quality playback will be able to implement high quality video display. In a surveillance camera system, for example only, this is effective in disclosing criminal information far and wide for early allocation and arrest of criminals.

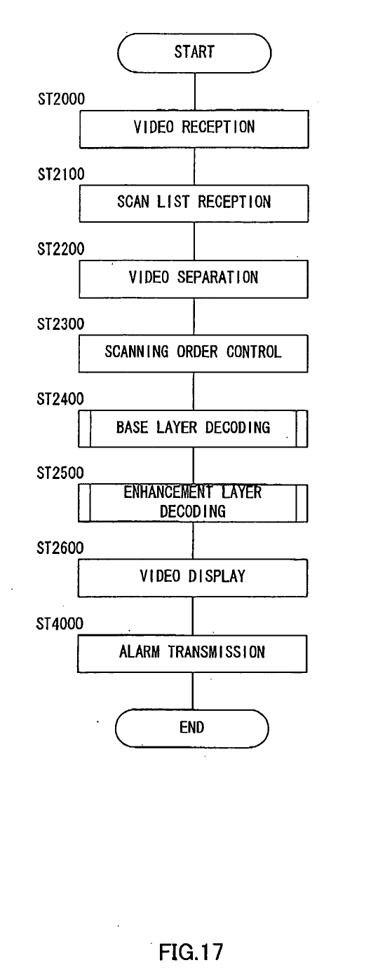

Next, the operation of video receiving apparatus 600 according to the present embodiment will be described with reference to the flowchart of FIG. 17. In the flowchart of the figure, steps that are identical to those in the flowchart of FIG. 9 are assigned the same numerals without further explanations.

Video receiving apparatus 600 of the present embodiment implements the operations of inputting and transmitting alarms, in addition to the video receiving operations by video receiving apparatus 300 of Embodiment 1(FIG. 2). That is, alarm input/transmitter 610 receives an alarm request as an input from a user monitoring the video displayed on video display 370, and, upon accepting this alarm request as an input, starts transmitting an alarm signal (ALARM) to video transmitting apparatus 500 and repeats the transmission at regular intervals (ST4000). The intervals between transmissions of the alarm signal (ALARM) are less than or the same as the video display intervals on video display 370. When an alarm cancel request is inputted from the user, alarm input/transmitter 610 stops transmitting the alarm signal (ALARM).

Thus, according to this embodiment, when unusual circumstances are detected in the course of image recognition by the video transmitting apparatus or during the monitoring by the user, the video transmitting apparatus cancels the privacy mode and scans the images in a normal mode scanning order and transmits the video stream. Consequently, in usual circumstance, privacy is protected. On the other hand, at times of unusual circumstance, such as when a criminal needs to be arrested promptly, it is possible to allow common users over a wide area to decode high quality surveillance camera video for improved possibility of allocating and arresting the criminal.

Although a case has been described with the present embodiment where alarm information cancels the privacy mode, the present invention is by no means limited to this, and it is equally possible to set the privacy mode in response to request from the user.

This makes possible privacy protection in accordance with requests from users at a high degree of freedom.

It is also possible to automatically change between a number of modes on a regular cycle in accordance with time information and the image number of input images. In this case, by reporting the mode change cycle to specific users alone in advance, it is possible to enable these specific users to implement high quality playback without constantly transmitting scan lists. This makes possible privacy protection at a high degree of freedom. For example, such a system is certainly possible whereby the privacy mode is automatically implemented during the night hours.

### Embodiment 3

It is a feature of Embodiment 3 of the present invention that certain blocks in an image, ones that are designated in the course of image recognition or designated by users, are scanned in scanning orders of a designated privacy mode and employ, generate, and transmit different scan lists from ones employed in the normal privacy mode.

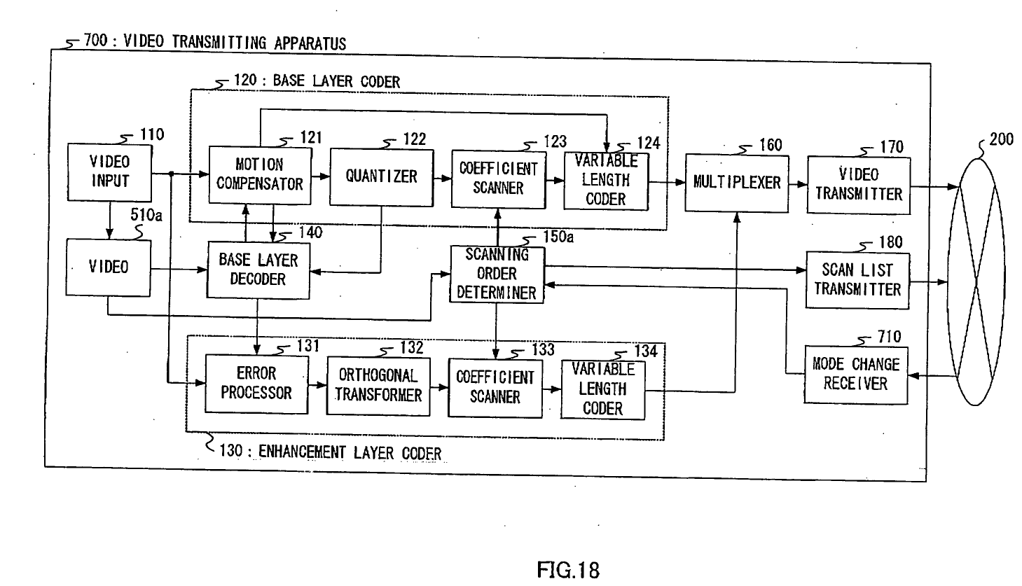

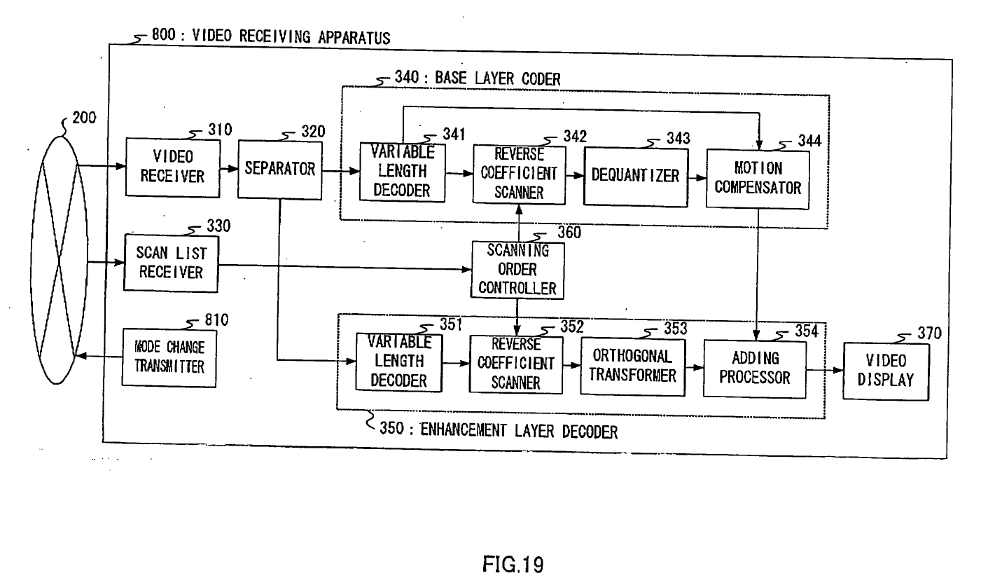

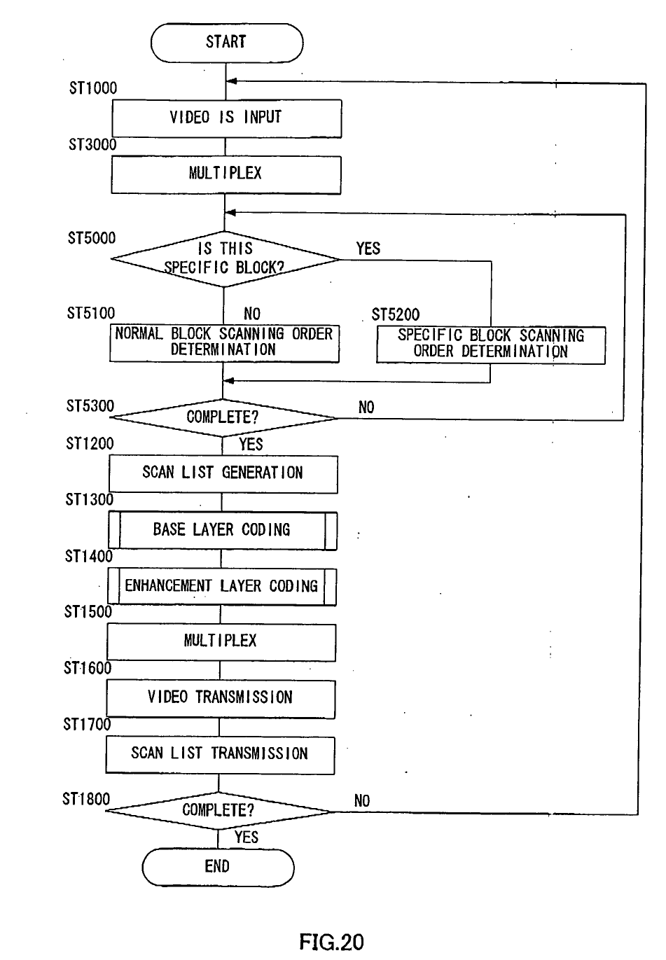

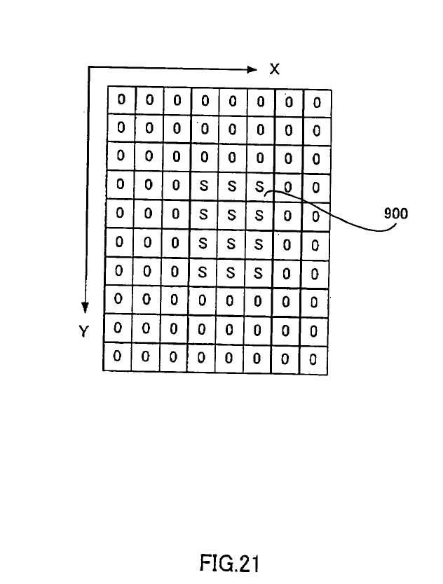

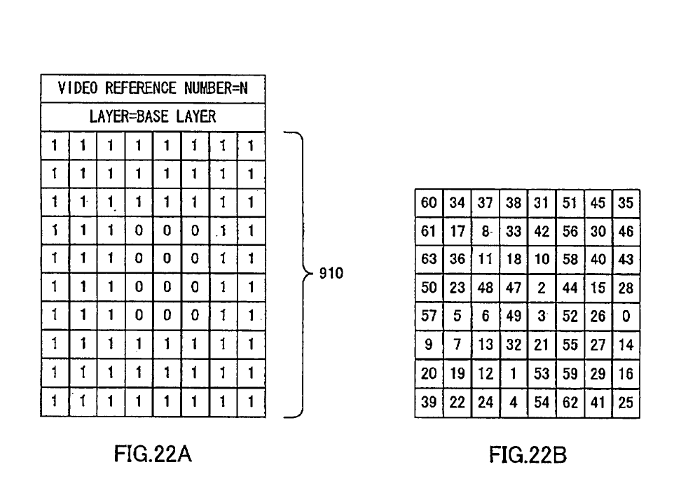

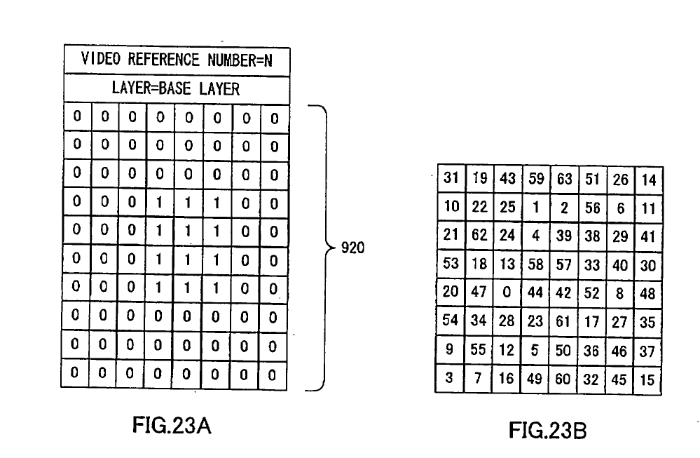

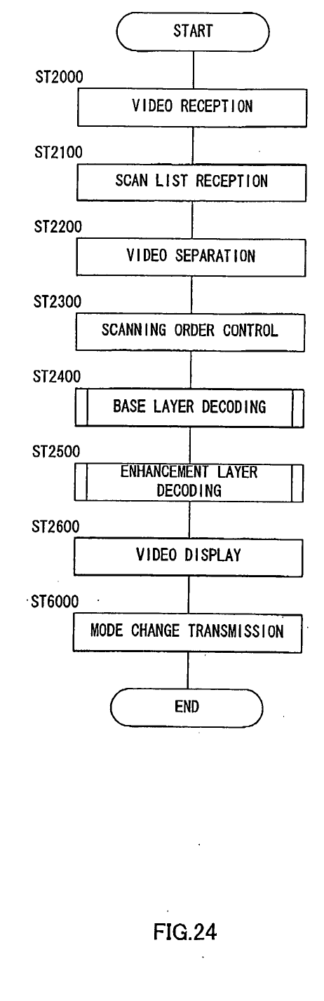

FIG. 18 is a block diagram showing the configuration of the video transmitting apparatus according to Embodiment 3 of the present invention. Parts in the video transmitting apparatus shown in the figure that are identical to those of the video transmitting apparatus shown in FIG. 1 and FIG. 13 are assigned the same reference numerals as in FIG. 1 and FIG. 13 without further explanations. Video transmitting apparatus 700 shown in FIG. 18 has video input 110, base layer coder 120, enhancement layer coder 130, base layer decoder 140, scanning order determiner 150b, multiplexer 160, video transmitter 170, scan list transmitter 180, image recognizer 510a, and mode change receiver 710.

Image recognizer 510a checks an input image outputted from video input 110 against registered images prestored in a database such as face images through image processing, and, upon detecting an object in the input image that matches a registered image, outputs three components of mode change information to scanning order determiner, including: a mode change signal (“PRIVACY”); the center frequency of the detected object (“G”); and the size of the detected object (“S”). In this embodiment, image recognizer 510a detects the face region, which is an important region in terms of privacy protection, and outputs the center coordinate (G) and size (S) of the face region with the mode change signal (PRIVACY).

Mode change receiver 710 receives the mode change information transmitted from video receiving apparatus 800 (described later) and outputs the information to scanning order determiner 150b.

Scanning order determiner 150b determines the scanning order of orthogonal transform coefficients on a per block basis in accordance with the mode change information inputted form image recognizer 510a and mode change receiver 710, and outputs individual scan lists for the blocks to coefficient scanner 123 and coefficient scanner 133.

FIG. 19 is a block diagram showing the configuration of the video receiving apparatus according to Embodiment 3 of the present invention. Parts in the video receiving apparatus shown in the figure that are identical to those in the video receiving apparatus shown in FIG. 2 and FIG. 14 are assigned the same reference numerals as in FIG. 2 and FIG. 14 without further explanations. Video receiving apparatus 800 shown in FIG. 19 has video receiver 310, separator 320, scan list receiver 330, base layer decoder 340, enhancement layer decoder 350, scanning order controller 360, video display 370, and mode change transmitter 810.

Mode change transmitter 810 receives from the user a mode change request as an input in respect to a region that particularly requires privacy protection (e.g. face region in this embodiment), and, upon accepting the mode change request as an input, transmits mode change information to video transmitting apparatus 700.

Next, the operation of video transmitting apparatus 700 having the above configuration will be descried with reference to the flowchart shown in FIG. 20.

In the flowchart shown in the figure, steps that are identical to those in the flowcharts of FIG. 3 and FIG. 15 are assigned the same reference numerals as in FIG. 3 and FIG. 15 without further explanations.

In addition, in the following explanation, all images are scanned in the privacy mode and normal mode scanning is not implemented.

Similar to the case of Embodiment 2, in this embodiment, too, image recognizer 510a implements image recognition in ST3000 and at the same time mode change receiver 710 constantly receives the mode change signal (PRIVACY) transmitted from video receiving apparatus 800. When mode change receiver 710 receives the mode change signal (PRIVACY), mode change information will be outputted to scanning order determiner 150b.

Then, scanning order determiner 150b determines whether or not a block in the image that is to be processed is one of specific blocks designated by he mode change information (ST5000). These “specific blocks” refer to the blocks inside the square defined by the center coordinate (G) and size (S) inputted with the mode change signal (PRIVACY). In this embodiment, these are the blocks in the face region.

If as a result of this determination the target block is a normal block and is not one of the specific blocks, the scanning orders of the base layer and the enhancement layer of this block are determined respectively in the privacy mode (in the normal privacy mode) as in Embodiment 1 (ST5100). At the same time, scanning order determiner 150b stores block index information signifying that the scanning order of the target block is one of the normal privacy mode.

On the other hand, if as a result of determination in ST5000 a target block is one of specific blocks, the scanning orders of the base layer and the enhancement layer of this block are determined in a designated privacy mode, which is different from the normal privacy mode (ST5200). At the same time, scanning order determiner 150b stores block index information signifying that the scanning order for the target block is one of the designated privacy mode.

FIG. 21 shows an example of block index information. The block index information shown in the figure has a grid structure containing the same number of components as all the blocks in an input image, in which each grid value indicates whether the block at this position is a specific block. That is, a block with the value of “S” in the grid is a specific block. A block with the value of “0” in the grid is a normal block. For example, block 900 has the value of S in the grid and is obviously a specific block.

Then, scanning order determiner 150b determines whether or not all the blocks in the image have scanning orders determined (ST5300). If the scanning orders have not been determined yet, the target block changes to other blocks and the process from ST5000 will repeat. On the other hand, if the scanning orders have been determined, scan lists are generated.

Upon generating the scan lists, scanning order determiner 150b utilizes block index information and generates the scan lists indicating the scanning orders of all blocks. That is, when the block index information shown in FIG. 21 is utilized, the scan lists shown in FIG. 22 and FIG. 23 are generated. That is, two scan lists are generated for the base layer and for the enhancement layer, one for the specific blocks having the grid value S in block index information and one for the normal blocks having the grid value 0, and the lists are transmitted to scan list transmitter 180.

FIG. 22A shows the scan list header in the normal privacy mode, formed with the reference number of the image to apply the scan matrix shown as FIG. 22B to, the layer, and block map 910, in which the positions of the blocks scanned in the normal privacy mode are shown with 1.

FIG. 23A shows the scan list header in a designated privacy mode, formed with the reference number of the image to apply the scan matrix shown as FIG. 23B to, the layer, and block map 920, in which the positions of the blocks scanned in the designated privacy mode are shown with 1.

These scan lists are transmitted from scan list transmitter 180 respectively to predetermined video receiving apparatus 800 via network 200. For example, the privacy mode scan list for the base layer is transmitted to common users. The privacy mode scan list for the enhancement layer is transmitted to the administrator. The designated privacy mode scan lists for the base layer and the enhancement layer are transmitted to, for example only, the residents living in or near the area surveillance cameras are installed. By this means, it is possible to improve the privacy of the residents whose face or body is recoded by the surveillance cameras. In addition, a privacy mode may be set on a per specific block basis to enable privacy protection at an improved degree of freedom.

Next, the operation of video receiving apparatus 800 according to the present embodiment will be described with reference to the flowchart of FIG. 24. In the flowchart shown in this figure, steps that are identical to the ones in the flowcharts shown in FIG. 9 and FIG. 17 are assigned the same reference numerals as in FIG. 9 and FIG. 17 without further explanations.

Video receiving apparatus 800 of the present embodiment implements the operation of transmitting mode change information, in addition to the video receiving operation by video receiving apparatus 300 of Embodiment 1 (FIG. 2). Mode change transmitter 810 transmits mode change information for setting of designated privacy modes to video transmitter 700 via network 200, including a mode change signal (PRIVACY), the center coordinate of a designated region (G), and the size of the designated region (S) (ST6000).

Thus, according to the present embodiment, the video transmitting apparatus makes scanning orders of the specific blocks positioned in a designated region different from the scanning orders for normal blocks positioned elsewhere. As a result, it is possible to maintain confidentiality at higher levels than when all blocks employ a common scanning order, and thus implement the privacy mode at a higher degree of freedom.

As described above, according to the present invention, a video communication terminal apparatus employs a configuration having: a determiner that determines a privacy mode scanning order, the scanning order being different from a normal mode scanning order; a scanner that scans orthogonal transform coefficients based on input video in the privacy mode scanning order; a coder that encodes scanned values and generates a video stream; and a transmitter that transmits the video stream and information about the privacy mode scanning order, and, in this apparatus, the transmitter transmits the information about the privacy mode scanning order only to specific users having authority to play the video stream. In this configuration, the video stream scanned in the privacy mode scanning order is transmitted, the information about the privacy mode scanning order is transmitted only to specific users, so that only these specific users receiving the information about the scanning order are able to reverse scan the video stream in the correct scanning order and decode the video stream, thereby improving confidentiality of video subject to transmission and reception without incurring increased processing load.

The video communication apparatus of the present invention may also employ a configuration, in which the scanner orthogonal transforms the input video, obtains orthogonal transform coefficients, corresponding respectively to individual pixels, and scans these coefficients in the privacy mode scanning order. In this configuration, the orthogonal transform coefficients are scanned in the privacy mode scanning order, so that, when coding schemes that apply the orthogonal transform to input video are employed, it is still possible to improve confidentiality of video subject to transmission and reception without incurring increased processing load.

The video communication apparatus of the present invention may also employ a configuration, in which the scanner orthogonal transforms residual images obtained based on correlation between frames in the input video, obtains the orthogonal transform coefficients, corresponding respectively to individual pixels, and scans these coefficients in the privacy mode scanning order. In this configuration, the residual images are subjected to the orthogonal transform and the resulting orthogonal transform coefficients are scanned in the privacy mode scanning order, so that, when coding schemes that apply the orthogonal transform to the residual images are employed, it is still possible to improve confidentiality of video subject to transmission and reception without incurring increased processing load and improve coding efficiency.

The video communication apparatus of the present invention may also employ a configuration, in which: the determiner determines a privacy mode scanning order for each of a plurality of layers forming the input video; the scanner scans the values of pixels in the privacy mode scanning order determined in association with the layer comprising the pixels; and the transmitter transmits individual information about the respective scanning orders of the plurality of layers depending on which of the plurality of layers the specific users each have authority to playback. In this configuration, scanning is implemented in the privacy mode scanning order determined per layer and the information about the scanning order per layer is transmitted depending on which of the plurality of layers the specific users each have authority to playback, so that it is possible to set the viewing authority of the specific users in multiple levels and enable privacy protection at a high degree of freedom.

The video communication apparatus of the present invention may also employ a configuration, in which the determiner leaves at least one of the plurality of layers without determining the privacy mode scanning order of said at least one of the plurality of layers, and the scanner scans the values of the pixels corresponding to said at least one of the plurality of layers in a normal mode scanning order. In this configuration, a layer scanned in the normal mode scanning order is transmitted, so that non-specific users are able to correctly decode this layer. For example, with a surveillance camera, it is possible to scan only the base layer, which is required for low quality playback, in the normal mode scanning order and disclose to the public summary video of the surveillance camera. As a result, the privacy of the object person is protected while the surveillance camera certainty improves the advantage of, for example only, crime prevention.

The video communication apparatus of the present invention may also employ a configuration, in which: the determiner determines a privacy mode scanning order for each of a plurality of blocks forming the input video, the plurality of blocks each comprising a predetermined number of pixels; the scanner scans values of pixels in the privacy mode scanning order determined in association with the block comprising the pixels; and the transmitter transmits individual information about the respective scanning orders of the plurality of blocks to the specific users. In this configuration, scanning is implemented in the privacy mode scanning order determined per block and the information about the scanning order per block is transmitted depending on which of the plurality of blocks the specific users each have authority to play, so that it is possible to improve confidentiality of video more intensely than when all blocks are scanned in a common scanning order.

The video communication apparatus of the present invention may also employ a configuration, in which: the determiner determines a designated privacy mode scanning order for at least one of the plurality of blocks corresponding to a designated region, the block corresponding to the designated region being identified in an image recognition result or being determined by a request from outside, the designated privacy mode scanning order being different from the privacy mode scanning orders determined in association with the rest of the plurality of blocks; and the transmitter transmits information about the designated privacy mode scanning order only to specific users having authority to play the block corresponding to the designated region. In this configuration, the block corresponding to the designated region is scanned in the designated privacy mode scanning order, so that it is possible to set the viewing authority of the specific users in multiple levels and thus enable privacy protection at a high degree of freedom.

The video communication apparatus of the present invention may also employ a configuration further having a privacy mode variable length code table, the table being different from a normal mode variable length code table, and, in this apparatus, values of pixels scanned in the privacy mode scanning order are coded utilizing the privacy mode variable length code table. In this configuration, when scanning is implemented in the privacy mode scanning order, the coding is implemented utilizing the privacy mode variable length code table, so that it is possible to prevent decrease in coding efficiency due to scanning in different scanning orders from normal mode scanning orders.

The video communication apparatus of the present invention may also employ a configuration, in which the transmitter transmits the privacy mode variable length code table only to specific users. In this configuration, the privacy mode variable length code table is transmitted only to specific users, so that it is possible to prevent decrease in coding efficiency, enable only those specific users that receive both the information about the scanning order and the variable length code table to correctly decode the video stream, and improve confidentiality of video. The video communication apparatus of the present invention may also employ a configuration, in which the transmitter encrypts the information about the privacy mode scanning order and transmits the information to the specific users. In this configuration, the information about the scanning order is encrypted, so that, even when the information about the scanning order is intercepted, the likelihood is still maintained low that the video stream is correctly decoded, so that it is possible to further improve confidentiality of video.

The video communication apparatus of the present invention may also employ a configuration, in which the determiner determines whether or not to employ the privacy mode scanning order according to an image recognition result or a request from outside, and, when the determiner determines not to employ the privacy mode scanning order, the scanner scans the values of pixels in the input video in a normal mode scanning order. In this configuration, scanning is implemented by switching dynamically between the privacy mode scanning order and the normal mode scanning order, so that it is possible to enable privacy protection at a high degree of freedom.

The video communication apparatus of the present invention may also employ a configuration, in which the determiner determines not to employ the privacy mode scanning order when an alarm alerts to the presence of unusual circumstances. In this configuration, scanning is implemented in the normal mode scanning order when there is an alarm, so that it is possible to enable privacy protection in normal times, and, on the other hand, disclose surveillance camera video to common non-specific users when there is an alarm such as when a criminal needs to be arrested promptly and thereby improve the possibility of allocating and arresting the criminal.

The video communication apparatus of the present invention may also employ a configuration, in which the determiner determines the privacy mode scanning order in a predetermined cycle and the transmitter transmits the information about the privacy mode scanning order per the predetermined cycle, or, alternatively, in this apparatus, the scanner switches between the privacy mode scanning order and the normal mode scanning order in the predetermined cycle and scans the values of pixels in the video input. In this configuration, the privacy mode scanning order is determined in a predetermined cycle and the information about the scanning order is transmitted per cycle, so that it is possible to reduce the processing load in the scanning order determination operation and reduce the impact of the transmission of the information about the scanning order against the bandwidth.

The video communication apparatus of the present invention may also employ a configuration having: a receiver that receives a video stream; a decider that determines whether or not information about a scanning order corresponding to the video stream is received; and a reverse scanner that reverse scans the video stream in accordance with the information about the scanning order when the information is received and that reverse scans the video stream in a normal mode scanning order when the information is not received. In this configuration, the video stream is reverse scanned in accordance with the information about the scanning order when the information is received, or the video stream is scanned in accordance with the normal mode scanning order when the information is not received, thereby limiting the operations of correctly decoding the video stream to where the authority is given to play the video stream, and improving confidentiality of video without incurring increased processing load.

In addition, a video communication method of the present invention has the steps of: determining a privacy mode scanning order, the scanning order being different from a normal mode scanning order; scanning orthogonal transform coefficients obtained from input video in the privacy mode scanning order; encoding scanned values and generating a video stream; and transmitting the video stream; and transmitting the information about the privacy mode scanning order only to specific users having authority to play the video stream. In this method, the video stream scanned in the privacy mode scanning order is transmitted and the information about the privacy mode scanning order is transmitted to the specific users alone, so that only these specific users that receive the information about the scanning order are allowed to reverse scan the video stream in the correct scanning order and decode the video stream, thereby improving confidentiality of video subject to transmission and reception without incurring increased processing load.

The video communication method of the present invention also has the steps of: receiving a video stream; determining whether or not information about a scanning order corresponding to the video stream is received; and reverse scanning the video stream in accordance with the information about the scanning order when the information is received and reverse scanning the video stream in accordance with a normal mode scanning order when the information is not received. In this method, the video stream is reverse scanned in accordance with the information about the scanning order when the information is received, or the video stream is scanned in accordance with the normal mode scanning order when the information is not received, thereby limiting the operations of correctly decoding the video stream to where the authority is given to play the video stream, and improving confidentiality of video without incurring increased processing load.

Thus, according to the present invention, orthogonal transform coefficients in video coding are scanned in different scanning orders from normal scanning orders and the scan lists are transmitted only to specific users. The present invention thus incurs minimum processing load, heightens confidentiality, and improves privacy in video transmission.

As a result, the video communication apparatus and video communication method of the present invention improve confidentiality of video subject to transmission and reception without incurring increased processing load. For example only, in a remote monitoring system where a number of surveillance cameras are employed to monitor remote locations, the present invention protects the privacy of the object person.

The present invention is not limited to the above described embodiments, and various variations and modifications are possible without departing from the scope of the invention.

This application is based on Japanese Patent Application No. 2004-033587 filed Feb. 10, 2004, entire content of which is expressly incorporated by reference herein.

FIG. 1
100 VIDEO TRANSMITTING APPARATUS
110 VIDEO INPUT
120 BASE LAYER CODER
121 MOTION COMPENSATOR
122 QUANTIZER
123 COEFFICIENT SCANNER
124 VARIABLE LENGTH CODER
130 ENHANCEMENT LAYER CODER
131 ERROR PROCESSOR
132 ORTHOGONAL TRANSFORMER
133 COEFFICIENT SCANNER
134 VARIABLE LENGTH CODER
140 BASE LAYER DECODER
150 SCANNING ORDER DETERMINER
160 MULTIPLEXER
170 VIDEO TRANSMITTER
180 SCAN LIST TRANSMITTER

FIG. 2
300 VIDEO RECEIVING APPARATUS
310 VIDEO RECEIVER
320 SEPARATOR
330 SCAN LIST RECEIVER
340 BASE LAYER DECODER
341 VARIABLE LENGTH DECODER
342 REVERSE COEFFICIENT SCANNER
343 DEQUANTIZER
344 MOTION COMPENSATOR
350 ENHANCEMENT LAYER DECODER
351 VARIABLE LENGTH DECODER
352 REVERSE COEFFICIENT SCANNER
353 ORTHOGONAL TRANSFORMER
354 ADDING PROCESSOR
360 SCANNING ORDER CONTROLLER
370 VIDEO DISPLAY

FIG. 3
START
1000 VIDEO IS INPUT
1100 SCANNING ORDER DETERMINATION
1200 SCAN LIST GENERATION
1300 BASE LAYER CODING
1400 ENHANCEMENT LAYER CODING
1500 MULTIPLEX
1600 VIDEO TRANSMISSION
1700 SCAN LIST TRANSMISSION
1800 COMPLETE?
END

FIG. 4
BASE LAYER CODING
1310 MOTION PREDICTION AND COMPENSATION
1320 ORTHOGONAL TRANSFORM AND QUANTIZATION COEFFICIENT SCANNING PROCESSING
1330 IS SCAN LIST INPUT?
1340 NORMAL MODE SCANNING
1350 PRIVACY MODE SCANNING
1360 VARIABLE LENGTH CODING
1370 BASE LAYER DECODING
RETURN

FIG. 5
ENHANCEMENT LAYER CODING
1410 VIDEO ERROR PROCESSING
1420 ORTHOGONAL TRANSFORM
1430 COEFFICIENT SCANNING PROCESSING
1440 VARIABLE LENGTH CODING
RETURN

FIG. 7A
VIDEO REFERENCE NUMBER=N
LAYER=BASE LAYER

FIG. 9
START
2000 VIDEO RECEPTION
2100 SCAN LIST RECEPTION
2200 VIDEO SEPARATION
2300 SCANNING ORDER CONTROL
2400 BASE LAYER DECODING
2500 ENHANCEMENT LAYER DECODING
2600 VIDEO DISPLAY
END

FIG. 10
BASE LAYER DECODING
2410 VARIABLE LENGTH DECODING
REVERSE COEFFICIENT SCANNING PROCESSING
2420 IS SCAN LIST INPUT?
2430 NORMAL MODE REVERSE SCANNING
2440 PRIVACY MODE REVERSE SCANNING
2450 ORTHOGONAL TRANSFORM AND DEQUANTIZATION
2460 MOTION COMPENSATION DECODING
RETURN

FIG. 12
ENHANCEMENT LAYER DECODING
2510 VARIABLE LENGTH DECODING
2520 REVERSE COEFFICIENT SCANNING PROCESSING
2530 ORTHOGONAL TRANSFORM
2540 VIDEO ADDING PROCESSING
RETURN

FIG. 13
[symbol] 1 [symbol] [symbol]
500 VIDEO TRANSMITTING APPARATUS
510 VIDEO
520 ALARM RECEIVER

FIG. 14
[symbol] 2 [symbol] [symbol]
600 VIDEO RECEIVING APPARATUS
610 ALARM INPUT·TRANSMITTER

FIG. 15
[symbol] 3 [symbol] [symbol]
3000 MULTIPLEX
3100 IS THERE ALARM?

FIG. 17
[symbol] 9 [symbol] [symbol]
4000 ALARM TRANSMISSION

FIG. 18
[symbol] 13 [symbol] [symbol]
700 VIDEO TRANSMITTING APPARATUS
710 MODE CHANGE RECEIVER

FIG. 19
[symbol] 14 [symbol] [symbol]
800 VIDEO RECEIVING APPARATUS
810 MODE CHANGE TRANSMITTER

FIG. 20
[symbol] 15 [symbol] [symbol]
5000 IS THIS SPECIFIC BLOCK?
5100 NORMAL BLOCK SCANNING ORDER DETERMINATION
5200 SPECIFIC BLOCK SCANNING ORDER DETERMINATION
5300 COMPLETE?

FIG. 22A
[symbol] 7A

[symbol]

[symbol]

FIG. 23A
[symbol] 7A

[symbol]

[symbol]

FIG. 24
[symbol] 9 [symbol] [symbol]
600 MODE CHANGE TRANSMISSION

1. A video communication apparatus comprising:
a determiner that determines a privacy mode scanning order, said scanning order being different from a normal mode scanning order;
a scanner that scans orthogonal transform coefficients obtained from input video in the privacy mode scanning order;
a coder that encodes scanned values and generates a video stream; and
a transmitter that transmits the video stream and information about the privacy mode scanning order,
wherein the transmitter transmits the information about the privacy mode scanning order only to specific users having authority to play the video stream.

2. The video communication apparatus of claim 1, wherein the scanner orthogonal transforms the input video, obtains the orthogonal transform coefficients, and scans said coefficients in the privacy mode scanning order.

3. The video communication apparatus according to claim 1, wherein the scanner orthogonal transforms residual images obtained based on correlation between frames in the input video, obtains the orthogonal transform coefficients, and scans said coefficients in the privacy mode scanning order.

4. The video communication apparatus according to claim 1, wherein:
the determiner determines a privacy mode scanning order for each of a plurality of layers forming the input video;
the scanner scans values of pixels in the privacy mode scanning order determined in association with the layer comprising said pixels; and
the transmitter transmits individual information about the respective scanning orders of the plurality of layers depending on which of the plurality of layers the specific users each have authority to playback.

5. The video communication apparatus according to claim 4, wherein:
the determiner leaves at least one of the plurality of layers without determining the privacy mode scanning order; and
the scanner scans the values of the pixels corresponding to said at least one of the plurality of layers without determining the privacy mode scanning order in a normal mode scanning order.

6. The video communication apparatus according to claim 1, wherein:
the determiner determines a privacy mode scanning order for each of a plurality of blocks forming the input video, said plurality of blocks each comprising a predetermined number of pixels;
the scanner scans values of pixels in the privacy mode scanning order determined in association with the block comprising said pixels; and
the transmitter transmits individual information about the respective scanning orders of the plurality of blocks to the specific users.

7. The video communication apparatus according to claim 6, wherein:
the determiner determines a designated privacy mode scanning order for at least one of the plurality of blocks corresponding to a designated region identified in an image recognition result or determined by a request from outside, said designated privacy mode scanning order being different from the privacy mode scanning orders determined in association with the rest of the plurality of blocks; and
the transmitter transmits information about the designated privacy mode scanning order only to specific users having authority to play the block corresponding to the designated region.

8. The video communication apparatus according to claim 1, further comprising a privacy mode variable length code table, said table being different from a normal mode variable length code table,
wherein values of pixels scanned in the privacy mode scanning order are coded utilizing the privacy mode variable length code table.

9. The video communication apparatus according to claim 8, wherein the transmitter transmits the privacy mode variable length code table only to the specific users.

10. The video communication apparatus according to claim 1, wherein the transmitter encrypts the information about the privacy mode scanning order and transmits said information to the specific users.

11. The video communication apparatus according to claim 1, wherein:
the determiner determines whether or not to employ the privacy mode scanning order based on an image recognition result or a request from outside; and
when the determiner determines not to employ the privacy mode scanning order, the scanner scans values of pixels in the input video in a normal mode scanning order.

12. The video communication apparatus according to claim 11, wherein the determiner determines not to employ the privacy mode scanning order when an alarm alerts to the presence of unusual circumstances.

13. The video of communication apparatus according to claim 1, wherein:
the determiner determines the privacy mode scanning order in a predetermined cycle; and
the transmitter transmits the information about the privacy mode scanning order per said predetermined cycle.

14. The video communication apparatus according to claim 1, wherein the scanner switches between the privacy mode scanning order and a normal mode scanning order in a predetermined cycle and scans values of pixels in the video input.

15. A video communication apparatus comprising:
a receiver that receives a video stream;
a decider that determines whether or not information about a scanning order corresponding to the video stream is received; and
a reverse scanner that reverse scans the video stream in accordance with the information about the scanning order when said information is received and that reverse scans the video stream in a normal mode scanning order when said information is not received.

16. A video communication method comprising the steps of:
determining a privacy mode scanning order, said scanning order being different from a normal mode scanning order;
scanning orthogonal transform coefficients obtained from input video in the privacy mode scanning order;
encoding scanned values and generating a video stream; and
transmitting the video stream; and
transmitting the information about the privacy mode scanning order only to specific users having authority to play the video stream.

17. A video communication method comprising the steps of:
receiving a video stream;
determining whether or not information about a scanning order corresponding to the video stream is received; and
reverse scanning the video stream in accordance with the information about the scanning order when said information is received and reverse scanning the video stream in a normal mode scanning order when said information is not received.
